(19) United States
(12) Patent Application Publication
(10) Pub. No.: US 2009/0174873 A1
(43) Pub. Date: Jul. 9, 2009

(54) EXPOSURE APPARATUS, EXPOSURE METHOD AND DEVICE MANUFACTURING METHOD

(75) Inventor: Takahisa KIKUCHI, Omiya (JP)

Correspondence Address: MILES & STOCKBRIDGE PC, 1751 PINNACLE DRIVE, SUITE 500, MCLEAN, VA, 22102-3833, US

(73) Assignee: NIKON CORPORATION

(21) Appl. No.: 12/333,852

(22) Filed: Dec. 12, 2008

Related U.S. Application Data
(60) Provisional application No. 61/006,070, filed on Dec. 17, 2007.

(51) Int. Cl. G03B 27/42

(52) U.S. Cl. 355/53

(57) ABSTRACT

An exposure apparatus that exposes a substrate is provided, the exposure apparatus comprising a first exposure system that drives a movable component which holds the substrate, and that, using patterned first exposure light, exposes a first shot area where a chip which is used to create a device can be formed on the substrate; and a second exposure system that comprises a holding component which is different from the movable component and is able to hold the substrate, and that, while relative movement between the substrate and patterned second exposure light, exposes a second shot area where the chip is not to be formed on the substrate using the second exposure light.

### CROSS-REFERENCE TO RELATED APPLICATION

This application is a non-provisional application claiming priority to and the benefit of U.S. provisional application No. 61/006,070, filed Dec. 17, 2007. The entire contents of which are incorporated herein by reference.

### BACKGROUND

1. Field of the Invention

The present invention relates to an exposure apparatus which exposes a substrate, an exposure method, and a device manufacturing method.

2. Description of Related Art

In order to form chips which are used to create a device, an exposure apparatus exposes shot areas on a substrate on which chips are able to be formed using exposure light which has been shaped into the pattern of the chips. In order to then suppress any deterioration of the devices (i.e., the chips) on the shot areas which is caused by various processings such as, for example, developing processing, etching processing, and CMP processing which are executed after the exposure processing, as is disclosed, for example, in U.S. Pat. No. 6,381,004 and PCT International Publication No. WO 2004/053951, what are known as edge shot areas (or notch shot areas), which are areas adjacent to the edges of a substrate where chips have not been formed, are also exposed using exposure light which has been shaped into a pattern of the chips.

If the edge shot areas are also exposed using an exposure apparatus in order to form the chip patterns, it is possible that there will be a reduction in throughput. Because of this, the development of technology that makes it possible to form a superior device while preventing any reduction in throughput is desired.

A purpose of some aspects of the present invention is to provide an exposure apparatus, an exposure method, and a device manufacturing method that make it possible to form a superior device while preventing any reduction in throughput.

### SUMMARY

In accordance with a first aspect of the present invention, there is provided an exposure apparatus that exposes a substrate, comprising: a first exposure system that drives a movable component which holds the substrate, and that, using patterned first exposure light, exposes a first shot area where a chip which is used to create a device can be formed on the substrate; and a second exposure system that comprises a holding component which is different from the movable component and is able to hold the substrate, and that, while relative movement between the substrate and patterned second exposure light, exposes a second shot area where the chip is not to be formed on the substrate using the second exposure light.

In accordance with a second aspect of the present invention, there is provided an exposure apparatus that exposes a substrate, comprising a first exposure system that, using patterned first exposure light, exposes a first shot area where a chip which is used to create a device can be formed on the substrate; and a second exposure system that exposes a second shot area where the chip is not to be formed on the substrate using the second exposure light, and by which a pattern created on the second shot area can be modified.

In accordance with a third aspect of the present invention, there is provided an exposure apparatus in which a second shot area of a substrate where first exposure light is not irradiated that is located between a first shot area of the substrate which is exposed using patterned first exposure light and an edge of the substrate is exposed using patterned second exposure light while relative movement between the second exposure light and the substrate.

In accordance with a fourth aspect of the present invention, there is provided an exposure apparatus in which a second shot area of a substrate where first exposure light is not irradiated that is located between a first shot area of the substrate, which is exposed using first exposure light which has been provided with a pattern by a first mask, and an edge of the substrate is exposed using second exposure light which has been provided with a pattern by a second mask having substantially the same pattern density as the pattern density of the first mask.

In accordance with a fifth aspect of the present invention, there is provided an exposure apparatus in which a second shot area located outside an effective exposure range on a substrate where a first shot area which has been exposed using patterned first exposure light is located is exposed using patterned second exposure light whose pattern density can be varied.

In accordance with a sixth aspect of the present invention, there is provided an exposure apparatus in which an operation to expose a second shot area which is located outside an effective exposure range of one of a first and a second substrate using patterned second exposure light is executed in parallel with at least a portion of an operation to expose a first shot area which is located within the effective exposure range of the other of the first and the second substrate using patterned first exposure light.

In accordance with a seventh aspect of the present invention, there is provided a device manufacturing method comprising: exposing a substrate using the exposure apparatus according to any one of the above described aspects; and developing the exposed substrate.

In accordance with an eighth aspect of the present invention, there is provided an exposure method for exposing a substrate comprising: exposing a first shot area on a substrate with patterned first exposure light by driving a movable component which holds the substrate, a chip which is used to create a device being formed in the first shot area; and exposing a second shot area on the substrate with patterned second exposure light by relative movement between the substrate and the second exposure light, the substrate being held by a holding component which is different from the movable component, no chip being formed in the second shot area.

In accordance with a ninth aspect of the present invention, there is provided an exposure method for exposing a substrate comprising: exposing a first shot area with a first exposure light, a first mask providing a pattern to the first exposure light, a chip which is used to create a device being formed in the first shot area; and exposing a second shot area with a second exposure light, a second mask providing a pattern to the second exposure light, the second mask having a pattern density substantially same as a pattern density of the first mask, no chip being formed in the second shot area.

In accordance with a tenth aspect of the present invention, there is provided an exposure method in which a second shot area of a substrate where first exposure light is not irradiated that is located between a first shot area of the substrate which is exposed using patterned first exposure light and an edge of the substrate is exposed using patterned second exposure light while relative movement between the second exposure light and the substrate.

In accordance with an eleventh aspect of the present invention, there is provided an exposure method in which a second shot area of a substrate where first exposure light is not irradiated that is located between a first shot area of the substrate, which is exposed using first exposure light which has been shaped into a pattern by a first mask, and an edge of the substrate is exposed using second exposure light which has been shaped into a pattern by a second mask having substantially a pattern destiny substantially same as a pattern density of the first mask.

In accordance with a twelfth aspect of the present invention, there is provided an exposure method in which a second shot area located outside an effective exposure range on a substrate where a first shot area which has been exposed using patterned first exposure light is located is exposed using patterned second exposure light whose pattern density can be varied.

In accordance with a thirteenth aspect of the present invention, there is provided an exposure method in which an operation to expose second shot area which is located outside an effective exposure range of one of a first and a second substrate using patterned second exposure light is executed in parallel with at least a portion of an operation to expose a first shot area which is located within the effective exposure range of the other of the first and the second substrate using patterned first exposure light.

In accordance with a twelfth aspect of the present invention, there is provided a device manufacturing method comprising: exposing a substrate using the exposure method according to any one of the above described aspects; and developing the exposed substrate.

According to some aspects of the present invention, it is possible to form a superior device while preventing any reduction in throughput.

### BRIEF DESCRIPTION OF THE DRAWINGS

FIG. 1 is a schematic structural view showing an example of a device manufacturing system according to a first embodiment.

FIG. 2 is a plan view showing a portion of a device manufacturing system according to the first embodiment.

FIG. 3 is a view intended to illustrate normal shot areas and edge shot areas.

FIG. 4 is a view showing an enlargement of a portion of FIG. 3.

FIG. 5 is a perspective view showing an example of a second exposure system according to the first embodiment.

FIG. 6 is a schematic structural view showing a portion of the second exposure system according to the first embodiment.

FIG. 7A is a typical view intended to illustrate a relationship between a pattern density of a mask and a pattern.

FIG. 7B is a typical view intended to illustrate a relationship between a pattern density of a mask and a pattern.

FIG. 8A is a typical view intended to illustrate an example of an exposure method according to the first embodiment.

FIG. 8B is a typical view intended to illustrate an example of an exposure method according to the first embodiment.

FIG. 8C is a typical view intended to illustrate an example of an exposure method according to the first embodiment.

FIG. 9 is a typical view intended to illustrate an example of an exposure method according to a second embodiment.

FIG. 10 is a typical view intended to illustrate an example of an exposure method according to a third embodiment.

FIG. 11 is a typical view showing an example of a second exposure system according to a fourth embodiment.

FIG. 12 is a view showing a portion of the second exposure system according to the fourth embodiment.

FIG. 13 is a view showing an example of the second exposure system according to the fourth embodiment.

FIG. 14 is a typical view showing an example of a second exposure system according to a fifth embodiment.

FIG. 15A is a typical view showing an example of a second exposure system according to a fifth embodiment.

FIG. 15B is a typical view showing an example of a second exposure system according to a fifth embodiment.

FIG. 16 is a typical view showing an example of a second exposure system according to a fifth embodiment.

FIG. 17A is a typical view showing an example of a second exposure system according to a fifth embodiment.

FIG. 17B is a typical view showing an example of a second exposure system according to a fifth embodiment.

FIG. 18 is a typical view showing an example of a second exposure system according to a fifth embodiment.

FIG. 19A is a typical view showing an example of a second exposure system.

FIG. 19B is a typical view showing an example of a second exposure system.

FIG. 20 is a typical view showing an example of a second exposure system.

FIG. 21 is a view intended to illustrate normal shot areas and edge shot areas.

FIG. 22 is a flow chart showing an example of a micro device manufacturing process.

### DESCRIPTION OF EMBODIMENTS

Embodiments of the present invention will now be described with reference made to the drawings, however, the present invention is not limited to these. In the description below, an XYZ rectangular coordinate system is set, and positional relationships between the respective components are described with reference made to this XYZ rectangular coordinate system. A predetermined direction within a horizontal plane is taken as an X axial direction, a direction which is orthogonal to the X axial direction within the horizontal plane is taken as a Y axial direction, while a direction which is orthogonal to both the X axial direction and the Y axial direction (namely, a vertical direction) is taken as a Z axial direction. Moreover, rotation (i.e., tilt) directions around the X axis, the Y axis, and the Z axis are taken respectively as θX, θY, and θZ directions.

### First Embodiment

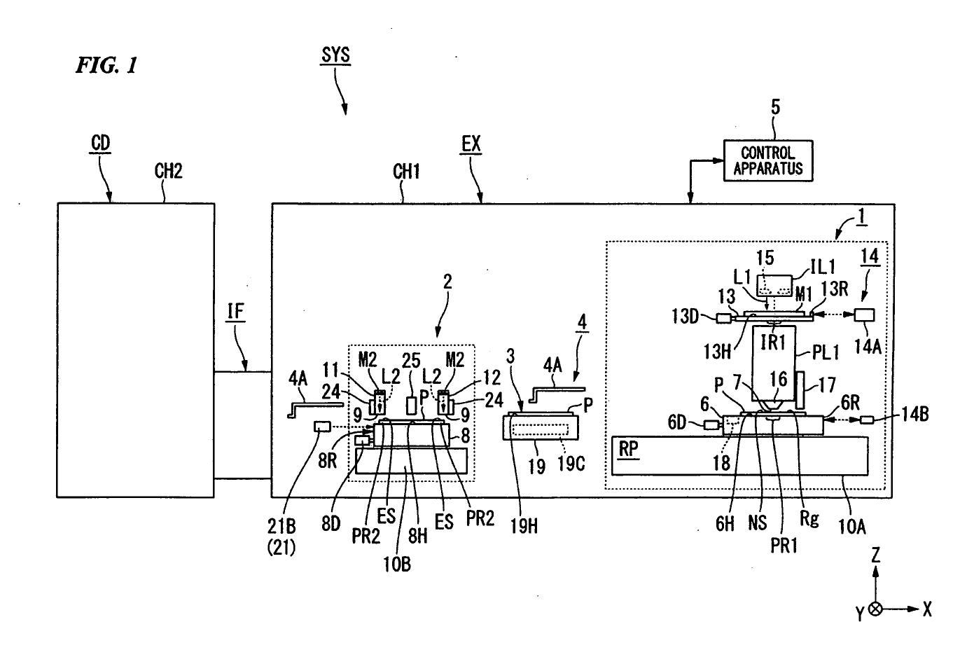

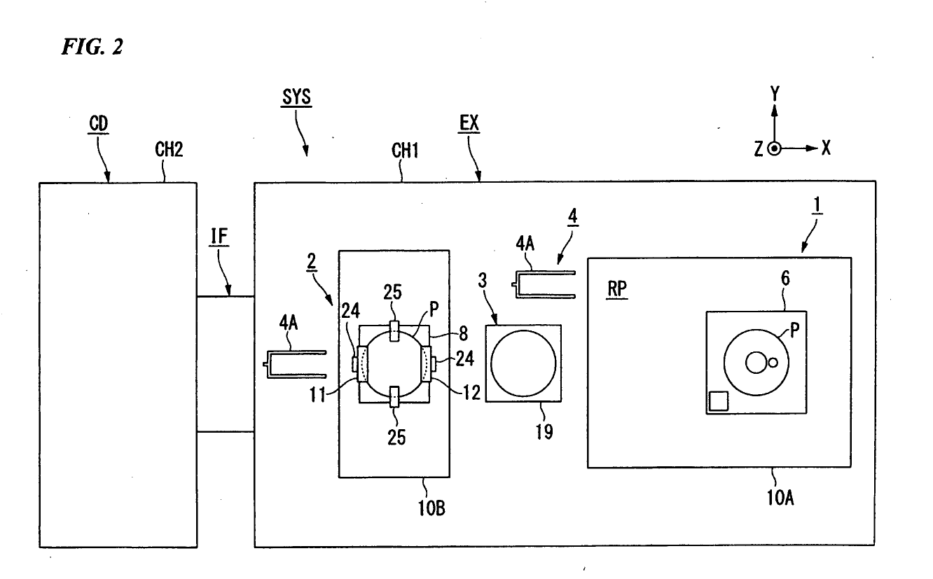

A first embodiment will now be described. FIG. 1 is a schematic structural view showing an example of a device manufacturing system SYS according to a first embodiment. FIG. 2 is a plan view showing the device manufacturing system SYS in typical form. In FIGS. 1 and 2, the device manufacturing system SYS is provided with an exposure apparatus EX which exposes a substrate P, and a coater developer apparatus CD. The exposure apparatus EX is provided with a first chamber apparatus CH1 which forms an internal space where a substrate P is processed. The coater developer apparatus CD is provided with a second chamber apparatus CH2 which forms an internal space where a substrate P is processed. The first chamber apparatus CH1 and the second chamber apparatus CH2 are both able to adjust the environments (i.e., the temperature, humidity, and level of sanitation) in their interior spaces. The exposure apparatus EX and the coater developer apparatus CD are connected via an interface IF.

The substrate P is a substrate which is used to manufacture chips for creating devices, and includes, for example, silicon wafers which are created by forming a photosensitive film Rg on a base material such as a semiconductor wafer. The photosensitive film Rg is a film of photosensitive material (i.e., photoresist). The coater developer apparatus CD includes a film forming apparatus which is able to form the photosensitive film Rg on a substrate P, and a developing apparatus which is able to develop the substrate P after exposure has been completed.

The exposure apparatus EX is provided with a first exposure system 1 which, using first exposure light L1 which has been shaped into a pattern, exposes first shot areas (chip forming area) NS of a substrate P on which chips which are used to create a device can be formed, a second exposure system 2 which, using second exposure light L2 which has been shaped into a pattern, exposes second shot areas (chip non-forming area) ES of a substrate P on which chips are not formed, a temperature adjustment apparatus 3 which adjusts the temperature of the substrate P, a transporting system 4 which transports the substrate P, and a control apparatus 5 which controls the overall operations of the exposure apparatus EX. The control apparatus 5 includes, for example, a computer system.

The first exposure system 1 drives a first substrate stage 6 which is holding the substrate P, and, in order to form a chip on the first shot areas NS on the substrate P, exposes the first shot areas NS using the first exposure light L1 which has been shaped into a chip pattern. The first exposure system 1 has an emission section (i.e., an emission surface) 7 which emits the pattern-shaped first exposure light L1, and irradiates the first exposure light L1 onto an irradiation area PR1 on the substrate P. The first exposure system 1 exposes the first shot areas NS using the first exposure light L1 while relative movement between the irradiation area PR1 and the substrate P.

The second exposure system 2 has a second substrate stage 8 which holds the substrate P and which is different from the first substrate stage 6, and exposes the second shot areas ES using the second exposure light L2 while relative movement between the substrate P and the second exposure light L2, which has been shaped into a predetermined pattern. The second exposure system 2 has an emission section (i.e., an emission surface) 9 which emits the pattern-shaped second exposure light L2, and irradiates the second exposure light L2 onto an irradiation area PR2 on the substrate P. The second exposure system 2 exposes the second shot areas ES using the second exposure light L2 while moving the irradiation area PR2 and the substrate P relatively to each other.

In the present embodiment, the second exposure system 2 is provided with a first exposure section 11 and a second exposure section 12 that each have an emission section 9 which emits the second exposure light L2. Namely, the second exposure system 2 has two emission sections 9, and is able to simultaneously irradiate the second exposure light L2 onto each one of the two irradiation areas PR2 which are located at different positions on the substrate P. In the present embodiment, the second exposure system 2 is able to simultaneously expose two second shot areas ES using the second exposure light L2 by using the first exposure section 11 and the second exposure section 12.

In the present embodiment, the first exposure system 1 provides a pattern to the first exposure light L1 using a first mask M1, and the second exposure system 2 provides a pattern to the second exposure light L2 using a second mask M2. The first mask M1 includes a reticle on which is formed a pattern (i.e., a chip pattern) which is used to provides a pattern to the first exposure light L1. The second mask M2 includes a reticle on which is formed a pattern which is used to provides a pattern to the second exposure light L2. The reticle includes a transmission type of mask which is created by forming a predetermined pattern on a transparent plate such as a glass plate using, for example, a light-blocking film such as chrome. This transmission mask is not limited to being a binary mask on which a pattern is formed using a light-blocking film, and includes phase-shifted masks such as, for example, half-tone type and spatial frequency modulation type masks. Moreover, in the present embodiment, a transmission type mask is used for the first mask M1 and the second mask M2, however, it is also possible to use a reflection type mask instead.

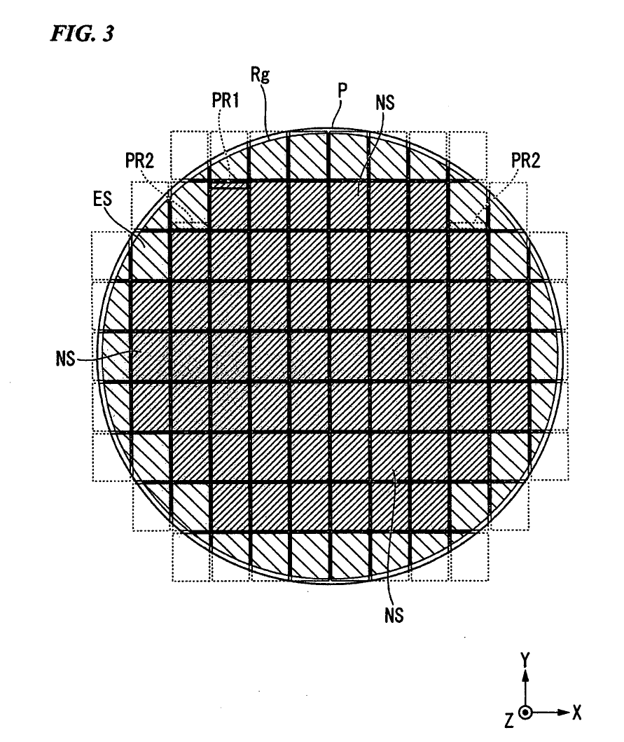

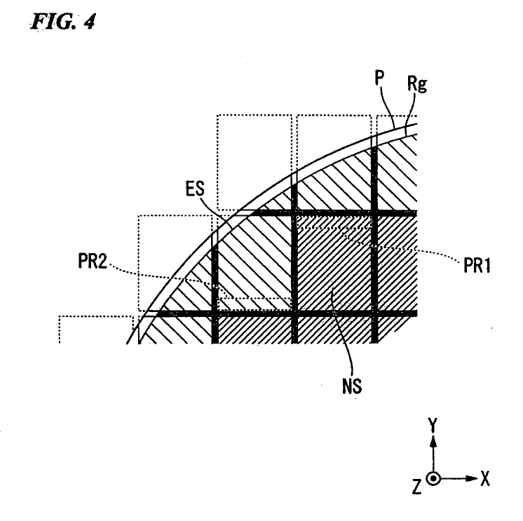

A description will now be given of the first shot areas NS and the second shot areas ES using FIG. 3 and FIG. 4. FIG. 3 is a plan view illustrating the first shot areas NS and the second shot areas ES on a substrate P, while FIG. 4 is an enlarged view of a portion of FIG. 3.

The first shot areas NS are areas on which chips which are used to create devices which become products are formed on the substrate P. The first shot area NS is area (chip forming area) where the one chip or more chips can be formed. In the present embodiment, the first shot area has a predetermined size which allows one chip to be formed. In order to form chips on the first shot areas NS on the substrate P, the first shot areas NS are exposed using the first exposure light L1 which has been shaped into a chip pattern by means of the first exposure system 1.

The first shot areas NS are located inside an effective exposure range of the substrate P excluding areas adjacent to the edge of the surface of the substrate P. The effective exposure range is the range of the majority portion of the surface of the substrate P which is formed by the photosensitive film Rg and includes the center of the surface of the substrate P. The effective exposure range is the range where the first shot areas NSD are able to be placed, and is a range where chip patterns can be formed with the desired level of accuracy.

In the present embodiment, after processing to form the photosensitive film Rg on the substrate P has been executed in the coater developer apparatus CD, edge rinse processing to remove photosensitive film Rg present on the edge of the substrate P is performed. In the vicinity of the edge of the substrate P there is a non-effective exposure range which includes a circular belt-shaped edge rinse area where the photosensitive film Rg is not present, and a circular belt-shaped margin area having a predetermined width which is on the inner side of the edge rinse area. The non-effective exposure range is a range where it is difficult to form chip patterns with the desired level of accuracy. In the present embodiment, the effective exposure range is on the inner side of the non-effective exposure range. Note that in the present embodiment, the non-effective exposure range includes an edge rinse area where edge rinsing has been performed, however, it is not necessary for this edge rinsing to be performed.

In the present embodiment, a plurality of the first shot areas NS are set in a matrix shape within the effective exposure range on the surface of the substrate P. In the present embodiment, each one of the first shot areas NS has substantially the same size.

The second shot area ES is area (chip non-forming area) on the substrate P where chips are not formed. The second shot areas ES are areas where it is not possible for chips to be placed (i.e. not possible for chips to be formed), and are smaller than the first shot areas NS. Namely, chips which are able to be placed in the first shot areas NS would have a portion thereof protruding onto the outer side of the substrate P (i.e., onto the outer side of the effective exposure range) in the second shot areas ES. The second shot areas ES are placed between the first shot areas NS and the edge of the substrate P. The second shot areas ES are not irradiated with the first exposure light L1 for forming chips which will be used to create products. The second shot areas ES are exposed by the second exposure system 2 using the second exposure light L2 which has been shaped into a predetermined pattern.

A plurality of the second shot areas ES are placed between the first shot areas NS which are placed in the effective exposure range and the edge of the substrate P. In the present embodiment, at least a portion of the second shot areas ES are set on the outer side of the effective exposure range of the substrate P. The outer side of the effective exposure range includes the above described non-effective exposure range.

In the description below, the first shot areas NS are suitably referred to as normal shot areas NS, and the second shot areas ES are suitably referred to as edge shot areas ES.

In the present embodiment, the first substrate stage 6 holds a substrate P such that the surface of the substrate P is substantially parallel with an XY plane. As is shown in FIG. 3 and FIG. 4, the irradiation area PR1 of the first exposure light L1 on the substrate P which is being held on the first substrate stage 6 are in the shape of a slit which is elongated in the X axial direction. The first exposure system 1 allows relative movement between the substrate P and the irradiation area PR1 in the Y axial direction, and exposes the normal shot areas NS using the first exposure light L1.

Moreover, the second substrate stage 8 holds the substrate P such that the surface of the substrate P is substantially parallel with the XY plane. As is shown in FIG. 3 and FIG. 4, the irradiation area PR2 of the second exposure light L2 on the substrate P which is being held on the second substrate stage 8 are in the shape of a slit which is elongated in the X axial direction. The second exposure system 2 allows relative movement between the substrate P and the irradiation area PR2 in the Y axial direction, and exposes the edge shot areas ES using the second exposure light L2.

A description will now be given of the first exposure system 1 with reference made to FIG. 1 and FIG. 2. The first exposure system 1 is provided with a first mask stage 13 which is able to move while holding a first mask M1, a first substrate stage 6 which is able to move while holding a substrate P, an interferometer system 14 which measures position information relating to the first mask stage 13 and the first substrate stage 6, a first illumination system IL1 which illuminates the first mask M1 using the first exposure light L1, and a first projection optical system PL1 which projects an image of the pattern on the first mask M1 which is illuminated by the first exposure light L1 onto the substrate P.

The first illumination system IL1 illuminates an illumination area IR1 on the first mask M1 using the first exposure light L1 which has a uniform brightness distribution. The first exposure light L1 which is emitted from the first illumination system IL1 may be provided by, for example, deep ultraviolet light (DUV light) such as emission rays (i.e., g-rays, h-rays, and i-rays) emitted from a mercury lamp and KrF excimer laser light (having a wavelength of 248 nm), and vacuum ultraviolet light (VUV light) such as ArF excimer laser light (having a wavelength of 193 nm) and F2 laser light (having a wavelength of 157 nm). In the present embodiment, ArF excimer laser light which is ultraviolet light (i.e., vacuum ultraviolet light) is used for the first exposure light L1.

The first illumination system IL1 is provided with an adjustment mechanism (masking system) 15 such as that disclosed in, for example, U.S. Pat. No. 6,597,002 which is able to adjust the illumination area IR1 on the first mask M1. The adjustment mechanism 15 is able to adjust the size, the position, and the shape of the illumination area IR1. The adjustment mechanism 15 is able to adjust the irradiation area PR1 on the substrate P by adjusting the illumination area IR1 on the first mask M1.

The first mask stage 13 has a holding portion 13H on which the first mask M1 is able to be removably mounted, and when the first mask M1 is being held on the holding portion 13H, the first mask stage 13 is able to move in at least three directions, namely, the X axial direction, the Y axial direction, and the θZ direction. The first mask stage 13 is moved by the operation of a drive system 13D which includes an actuator such as a linear motor or the like. A laser interferometer 14A of the interferometer system 14 measures position information relating to the X axial direction, the Y axial direction, and the θZ direction of the first mask stage 13 using a measurement mirror 13R which is provided in the first mask stage 13. The control apparatus 5 performs positional control of the first mask M1 which is held on the first mask stage 13 by operating the drive system 13D based on measurement results from the interferometer system 14.

The first projection optical system PL1 projects an image of the pattern on the first mask M onto the substrate P at a predetermined projection factor. A plurality of optical elements of the first projection optical system PL1 are held in a lens barrel. The first projection optical system PL1 of the present embodiment is a reduction system whose projection factor is, for example, ¼, ⅕, ⅛ or the like. Note that the first projection optical system PL1 may also be either an equalizing system or an enlargement system. In the present embodiment, the optical axis of the first projection optical system PL1 is parallel with the Z axis. Moreover, the first projection optical system PL1 may be either a dioptric system that does not include any catoptric elements, a catoptric system that does not include any dioptric elements, or a catadioptric system that includes both catoptric elements and dioptric elements. Moreover, the first projection optical system PL1 may form either an inverted image or an erect image.

Of the plurality of optical elements of the first projection optical system PL1, a terminal optical element 16 which is closest to an image plane of the first projection optical system PL1 has the emission section 7 which emits the patterned first exposure light L1 which is to be irradiated onto the substrate P. The emission section 7 of the terminal optical element 16 and the surface of the substrate P which is being held on the first substrate stage 6 are able to face each other, and the first substrate stage 6 is able to move relative to the terminal optical element 16 while holding the substrate P.

The first substrate stage 6 has a holding portion 6H on which the substrate P is able to be removably mounted, and when the substrate P is being held on the holding portion 6H, the first substrate stage 6 is able to move in six directions on a surface plate 10A, namely, the X axial direction, the Y axial direction, the Z axial direction, and the θX, θY, and θZ directions. The first substrate stage 6 is moved by the operation of a drive system 6D which includes an actuator such as a linear motor or the like. A laser interferometer 14B of the interferometer system 14 measures position information relating to the X axial direction, the Y axial direction, and the θZ direction of the first substrate stage 6 using a measurement mirror 6R which is provided in the first substrate stage 6. In addition, surface position information (i.e., position information relating to the θX, the θY, and the Z axial direction) relating to the surface of the substrate P which is being held on the first substrate stage 6 is detected by a focus and leveling detection system (not shown). The control apparatus 5 performs positional control of the substrate P which is held on the first substrate stage 6 by operating the drive system 6D based on measurement results from the interferometer system 14 and on detection results from the focus and leveling detection system.

The first exposure system 1 is provided with an alignment system 17 which detects position information relating to at least the normal shot areas NS on the substrate P which is being held on the first substrate stage 6. The alignment system 17 is able to detect alignment marks which are formed on the substrate P so as to correspond to the normal shot areas NS. By detecting the alignment marks on the substrate P using the alignment system 17 while monitoring the position information for the first substrate stage 6 using the interferometer system 14, the control apparatus 5 is able to detect position information for the normal shot areas NS within an XY plane stipulated by the interferometer system 14. The alignment system 17 employs an FIA (Field Image Alignment) type of alignment system such as that disclosed, for example, in U.S. Pat. No. 5,493,403.

In the present embodiment, the control apparatus 5 executes EGA (enhanced global alignment) processing such as that disclosed, for example, in U.S. Pat. No. 4,780,617 using detection results from the alignment system 17, and is thereby able to derive position information for both the normal shot areas NS and the edge shot areas ES (including positional relationships between the normal shot areas NS and the edge shot areas ES).

The first exposure system 1 is also provided with a spatial image measuring system 18 such as that disclosed, for example, in United States Patent Application Publication No. 2002/0041377 A which measures spatial images from the first projection optical system PL1. A light receiving portion (i.e., an optical component such as a slit plate) of the spatial image measuring system 18 is placed on a light emission side (i.e., an image plane side) of the first projection optical system PL1, and the spatial image measuring system 18 detects a projection position of an image of a pattern from the first projection optical system PL1 (i.e., a position of the irradiation area PR1 of the first exposure light L1). In the present embodiment, the light receiving portion of the spatial image measuring system 18 is located on the first substrate stage 6.

When the normal shot areas NS of the substrate P are being exposed by the first exposure system 1, the control apparatus 5 detects the alignment marks formed on the substrate P which is being held on the first substrate stage 6 using the alignment system 17 while monitoring the position information for the first substrate stage 6 using the interferometer system 14, and detects position information for the normal shot areas NS within an XY plane stipulated by the interferometer system 14. Moreover, the control apparatus 5 detects a spatial image from the first projection optical system PL1 using the spatial image measuring system 18 while monitoring position information for the first substrate stage 6 using the interferometer system 14, and detects the projection position of the image of the pattern from the first projection optical system PL1 within the XY plane stipulated by the interferometer system 14. Based on position information for the normal shot areas NS and for the projection position of the image of the pattern from the first projection optical system PL1 which have been determined using the alignment system 17 and the spatial image measuring system 18, the control apparatus 5 adjusts the positional relationship between the normal shot areas NS and the projection position of the image of the pattern from the first projection optical system PL1, and exposes each one of the normal shot areas NS using the patterned first exposure light L1.

The first exposure system 1 of the present embodiment projects an image of the pattern on the first mask M1 onto the substrate P while moving the first mask M1 and the substrate P in synchronization with each other in the Y axial direction. The first exposure system 1 moves the substrate P in the Y axial direction to the irradiation area PR1 of the first exposure light L1 emitted from the emitting section 7 of the terminal optical element 16 (i.e., to the projection area of the first projection optical system PL1), and, while moving the first mask M1 in the Y axial direction to the illumination area IR1 of the first illumination system IL1 in synchronization with the movement of the substrate P in the Y axial direction, also irradiates the first exposure light L1 onto the substrate P via the first projection optical system PL1 and thereby exposes the normal shot areas NS on the substrate P using the first exposure light L1.

The first mask M1 has a pattern formation area on which chip patterns are formed. In the present embodiment, the chip pattern (which is used to form a chip on the substrate P for creating a device which will become a product) for a single chip is placed in the pattern formation area of the first mask M1.

The normal shot areas NS include a first position where, in a scan exposure performed by the first exposure system 1, a rear end of the irradiation area PR1 immediately after the scan exposure commences matches a front end of the normal shot areas NS, and a second position where the front end of the irradiation area PR1 immediately before the scan exposure ends matches a rear end of the normal shot areas NS. An image of the entire pattern of the pattern formation area which includes the front end and the rear end of the pattern formation area of the first mask M1 during a scan exposure can be exposed (projected) in the normal shot area NS in a single scan operation. Namely, in the present embodiment, a single chip is formed in a single normal shot area NS.

Next, a description will be given of the temperature adjustment apparatus 3 and the transporting system 4. The temperature adjustment apparatus 3 adjusts the temperature of the substrate P before it is exposed by the first exposure system 1. The temperature adjustment apparatus 3 is controlled by the control apparatus 5. The temperature adjustment apparatus 3 has a holding component 19 which has a holding portion 19H on which a substrate P can be removably mounted, and a temperature adjustment mechanism 19C which is provided in the holding component 19. The temperature adjustment mechanism 19C includes a heating mechanism and a cooling mechanism, and is able to adjust the temperature of the substrate P being held on the holding portion 19H. The temperature adjustment apparatus 3 uses the temperature adjustment mechanism 19C to adjust the temperature of the substrate P being held on the holding component 19.

The transporting system 4 is provided with a plurality of transporting components 4A which are able to transport a substrate P. The transporting system 4 is able to transport a substrate P which has been carried from the coater developer apparatus CD via the interface IF, and is also able to transport a substrate P to the coater developer apparatus CD. The transporting system 4 is able to transport a substrate P to the first exposure system 1 after it has been transported from the coater developer apparatus CD to the exposure apparatus EX and before it has been exposed by the first exposure system 1. Moreover, the transporting system 4 is able to transport a substrate P which has been exposed by the first exposure system 1 away from the first exposure system 1, and is able to then transport this substrate P to the coater developer apparatus CD. Using the transporting component 4A, the transporting system 4 is able to transport (i.e., load) a substrate P before the normal shot areas NS thereon have been exposed to the first substrate stage 6, and is able to transport (i.e., unload) the substrate P after the normal shot areas NS thereon have been exposed away from the first substrate stage 6.

When the control apparatus 5 loads a substrate P on the first substrate stage 6, or when it unloads a substrate P from the first substrate stage 6, it moves the first substrate stage 6 to a substrate switching position (i.e., loading position) RP. The transporting system 4 is able to execute at least one of transporting a substrate P either onto or away from the first substrate stage 6 which has been moved to the substrate switching position RP.

The temperature adjustment apparatus 3 is placed either on the transporting path of the substrate P from the coater developer apparatus CD to the first exposure system 1 or else adjacent to this path, and adjusts the temperature of the substrate P before it is transported to the first exposure system 1. Using the transporting component 4A, the transporting system 4 is able to transport (i.e., load) a substrate P to the holding component 19 of the temperature adjustment apparatus 3 before it is exposed by the first exposure system 1, and is able to transport (i.e., unload) the substrate P after the temperature thereof has been adjusted while it was being held on the holding component 19 away from the holding component 19, and then transport it to the first exposure system 1.

Next, a description will be given of the second exposure system 2. The second exposure system 2 is provided either on or adjacent to the transporting path of the substrate P along which it is transported by the transporting system 4. The transporting system 4 is able to transport a substrate P onto the second exposure system 2 before it is exposed by the second exposure system 2, and is able to transport the substrate P away from the second exposure system 2 after it has been exposed by the second exposure system 2. Using the transporting component 4A, the transporting system 4 is able to transport (i.e., load) a substrate P before the edge shot areas ES thereof have been exposed to the second substrate stage 8, and is able to transport (i.e., unload) the substrate P after the edge shot areas ES thereof have been exposed away from the second substrate stage 8.

In the present embodiment, the second exposure system 2 is provided either on or adjacent to the path along which the substrate P is transported from the first exposure system 1. The second exposure system 2 exposes a substrate P with the second exposure light L2 after it has been exposed by the first exposure system 1.

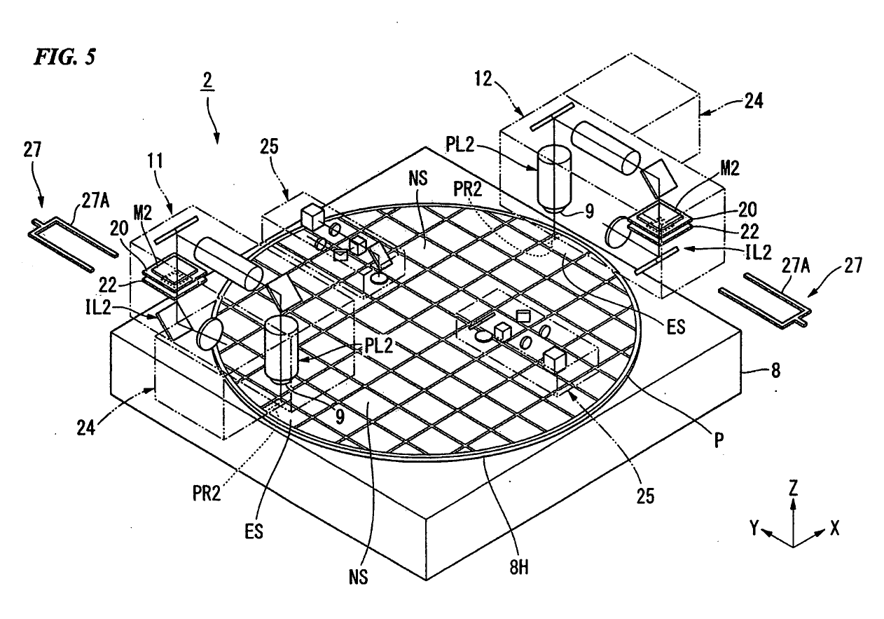

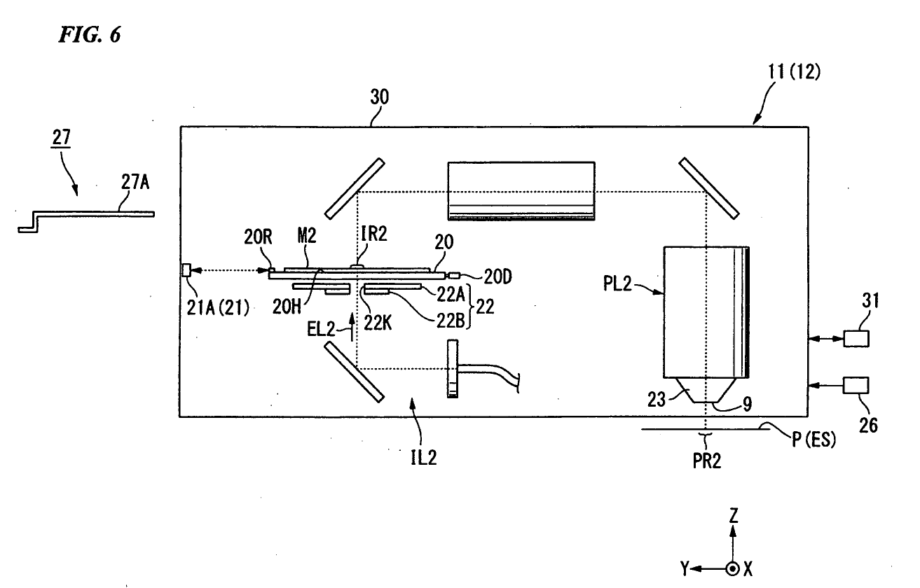

FIG. 5 is a perspective view showing the second exposure system 2, and FIG. 6 is a schematic structural view showing the first exposure section 11. In FIG. 1, FIG. 2, FIG. 5, and FIG. 6, the second exposure system 2 has the second substrate stage 8 which is able to move while holding a substrate P, and the first exposure section 11 and the second exposure section 12 which expose the edge shot areas ES on the substrate P which is being held on the second substrate stage 8 using the second exposure light L2 which has been shaped into a pattern by the second mask M2. As is described above, the second exposure system 2 is able to simultaneously irradiate the second exposure light L2 onto each one of two irradiation areas PR2 which are located at different positions on the substrate P using the first exposure section 11 and the second exposure section 12. In the present embodiment, the first exposure section 11 and the second exposure section 12 have an equivalent structure. In the description given below, the description centers mainly on the first exposure section 11, and a description of the second exposure section 12 is omitted.

The first exposure section 11 is provided with a second mask stage 20 which is able to move while holding the second mask M2, an interferometer system 21 which measures position information relating to the second mask stage 20 and the second substrate stage 8, a second illumination system IL2 which illuminates the second mask M2 using the second exposure light L2, and a second projection optical system PL2 which projects an image of the pattern on the second mask M2 which is illuminated by the second exposure light L2 onto the substrate P.

The second illumination system IL2 illuminates an illumination area IR2 on the second mask M2 using the second exposure light L2 which has a uniform brightness distribution. The second exposure light L2 which is emitted from the second illumination system IL2 may be provided by, for example, deep ultraviolet light (DUV light) such as emission rays (i.e., g-rays, h-rays, and i-rays) emitted from a mercury lamp and KrF excimer laser light (having a wavelength of 248 nm), and vacuum ultraviolet light (VUV light) such as ArF excimer laser light (having a wavelength of 193 nm) and F2 laser light (having a wavelength of 157 nm). In the present embodiment, the wavelength of the first exposure light L1 and the wavelength of the second exposure light L2 are substantially the same. Namely, in the present embodiment, ArF excimer laser light is used for the second exposure light L2. In the present embodiment, ArF excimer laser light emitted from a light source device (i.e., a laser device—not shown) is supplied to the second illumination system IL2 by a light guiding component such as an optical fiber.

The second illumination system IL2 has an adjustment mechanism (masking system) 22 which is able to adjust the illumination area IR2 on the second mask M2. In the present embodiment, the adjustment mechanism 22 includes a blind component 22A which has an aperture 22K and is placed in the vicinity of the second mask M2, and a blade component 22B which is able to move relative to the aperture 22K. The adjustment mechanism 22 is able to adjust the size, the position, and the shape of the illumination area IR2 by moving the blade component 22B relative to the aperture 22K. The adjustment mechanism 22 is able to adjust the irradiation area PR2 on the substrate P by adjusting the illumination area IR2 on the second mask M2. Note that an adjustment mechanism such as that disclosed in, for example, U.S. Pat. No. 6,597,002 can be used for the adjustment mechanism 22.

The second mask stage 20 has a holding portion 20H on which the second mask M2 is able to be removably mounted, and when the second mask M2 is being held on the holding portion 20H, the second mask stage 20 is able to move in at least three directions, namely, the X axial direction, the Y axial direction, and the θZ direction. The second mask stage 20 is moved by the operation of a drive system 20D which includes an actuator such as a linear motor or the like. A laser interferometer 21A of the interferometer system 21 measures position information relating to the X axial direction, the Y axial direction, and the θZ direction of the second mask stage 20 using a measurement mirror 20R which is provided in the second mask stage 20. The control apparatus 5 performs positional control of the second mask M2 which is held on the second mask stage 20 by operating the drive system 20D based on measurement results from the interferometer system 21.

The second projection optical system PL2 projects an image of the pattern on the second mask M2 onto the substrate P at a predetermined projection factor. A plurality of optical elements of the second projection optical system PL2 are held in a lens barrel. The second projection optical system PL2 of the present embodiment is a reduction system whose projection factor is, for example, ¼, ⅕, ⅛ or the like. Note that the second projection optical system PL2 may also be either an equalizing system or an enlargement system. In the present embodiment, the optical axis of the second projection optical system PL2 is parallel with the Z axis. Moreover, the second projection optical system PL2 may be either a dioptric system that does not include any catoptric elements, a catoptric system that does not include any dioptric elements, or a catadioptric system that includes both catoptric elements and dioptric elements. Moreover, the second projection optical system PL2 may form either an inverted image or an erect image.

In the present embodiment, the projection factor of the first projection optical system PL1 and the projection factor of the second projection optical system PL2 are substantially the same.

Of the plurality of optical elements of the second projection optical system PL2, a terminal optical element 23 which is closest to an image plane of the second projection optical system PL2 has the emission section 9 which emits the patterned second exposure light L2 which is to be irradiated onto the substrate P. The emission section 9 of the terminal optical element 23 and the surface of the substrate P which is being held on the second substrate stage 8 are able to face each other, and the second substrate stage 8 is able to move relative to the terminal optical element 23 while holding the substrate P.

The second substrate stage 8 has a holding portion 8H on which the substrate P is able to be removably mounted, and when the substrate P is being held on the holding portion 8H, the second substrate stage 8 is able to move in six directions on a surface plate 10B, namely, in the X axial direction, the Y axial direction, the Z axial direction, and the θX, θY, and θZ directions. The second substrate stage 8 is moved by the operation of a drive system 8D which includes an actuator such as a linear motor or the like. A laser interferometer 21B of the interferometer system 21 measures position information relating to the X axial direction, the Y axial direction, and the θZ direction of the second substrate stage 8 using a measurement mirror 8R which is provided in the second substrate stage 8. In addition, the first exposure section 11 is provided with a focus and leveling detection system 24 which detects surface position information (i.e., position information relating to the θX, the θY, and the Z axial directions) for the surface of the substrate P which is being held on the second substrate stage 8. The focus and leveling detection system 24 is, for example, an oblique incidence system, and includes a projector which irradiates detection light onto the substrate P from an oblique direction relative to the Z axis, and a light receiver which is able to receive detection light reflected by the substrate P. The control apparatus 5 performs positional control of the substrate P which is held on the second substrate stage 8 by operating the drive system 8D based on measurement results from the interferometer system 21 and on detection results from the focus and leveling detection system 24.

The second exposure system 2 is provided with an alignment system 25 which detects position information relating to at least the normal shot areas NS on the substrate P which is being held on the second substrate stage 8. The alignment system 25 is able to detect alignment marks which are formed on the substrate P so as to correspond to the normal shot areas NS. By detecting the alignment marks on the substrate P using the alignment system 25 while monitoring the position information for the second substrate stage 8 using the interferometer system 21, the control apparatus 5 is able to detect position information for the normal shot areas NS within an XY plane stipulated by the interferometer system 21. The alignment system 25 employs an FIA (Field Image Alignment) type of alignment system such as that disclosed, for example, in U.S. Pat. No. 5,493,403. In the present embodiment, two alignment systems 25 are provided. Moreover, in the present embodiment, the alignment systems 25 are able to move relatively to the substrate P.

Furthermore, in the present embodiment, the second exposure system 2 and is provided with a drive system 26 which is able to drive the first exposure section 11. The drive system 26 is able to move at least the second illumination system IL2, the second mask stage 20, the second projection optical system PL2, and the laser interferometer 21A in combination while maintaining the positional relationships between the second illumination system IL2, the second mask stage 20, the second projection optical system PL2, and the laser interferometer 21A. In the present embodiment, the second illumination system IL2, the second mask stage 20, the second projection optical system PL2, and the laser interferometer 21A and the like are located within a chamber 30, and are supported by a predetermined support mechanism. By moving this chamber 30, the drive system 26 is able to move the second illumination system IL2, the second mask stage 20, the second projection optical system PL2, and the laser interferometer 21A in combination. As a result of the first exposure section 11 being moved by the drive system 26, the emission section 9 of the terminal optical element 23 which emits the second exposure light L2 is also moved. The irradiation area PR2 is also moved as a result of the movement of the emission section 9. The drive amount of the drive system 26 (i.e., the amount of movement of the chamber 30) is measured by a measurement system 31 which includes an encoder system. In the same way, the second exposure system 2 is able to move the second exposure section 12 using the drive system 26.

The second exposure system 2 is able to vary the patterns created on the edge shot areas ES. Namely, the second exposure system 2 can expose the edge shot area ES with various patterns according to formation parameter (e.g., density, line width, pitch, or duty). In the present embodiment, the second exposure system 2 alters the patterns created on the edge shot areas ES in accordance with the patterns created on the normal shot areas NS by the first exposure system 1. Namely, the edge shot area ES is exposed with a pattern having a formation parameter having been altered. In the present embodiment, the second exposure system 2 is able to alter at least the density of the patterns created on the edge shot areas ES, as a formation parameter. In the present embodiment, the second exposure system 2 creates on the edge shot areas ES patterns which have substantially the same density as the patterns created on the normal shot areas NS by the first exposure system 1.

In the present embodiment, a plurality of the second masks M2 which have different pattern densities are prepared, and the second exposure system 2 switches the second masks M2 in accordance with the patterns created on the normal shot areas NS.

In the present embodiment, the first exposure section 11 of the second exposure system 2 is provided with a transporting system 27 which includes a transporting component 27A which carries out the transporting of a second mask M2 to the second mask stage 20 and also the transporting of a second mask M2 away from the second mask stage 20. The transporting system 27 is able to transport second masks M2 between a mask library (not shown), in which a plurality of the second masks M2 which have different pattern densities are housed, and the second mask stage 20. Moreover, as is described above, the second masks M2 are able to be removably mounted on the second mask stage 20. Accordingly, the first exposure section 11 is able to switch the second mask M2 on the second mask stage 20 using the second mask stage 20 on which the second masks M2 are able to be removably mounted, and the transporting system 27 which transports the second masks M2.

The control apparatus 5 switches the second mask M2 which is being held on the second mask stage 20 in accordance with the pattern created on the normal shot areas NS. The control apparatus 5 selects a predetermined second mask M2 from among the plurality of second masks M2 housed in the mask library so that patterns having substantially the same density as the patterns created on the normal shot areas NS are created on the edge shot areas ES, and then causes this selected second mask M2 to be held on the second mask stage 20.

In the present embodiment, the second exposure system 2 holds on the second mask stage 20 a second mask M2 having the same pattern density as the pattern density of the first mask M1 being used by the first exposure system 1, and provides a pattern to the second exposure light L2 using this second mask M2. As is described above, in the present embodiment, the projection factor of the first projection optical system PL1 and the projection factor of the second projection optical system PL2 are substantially the same. As a result of this, the second exposure system 2 is able to create on the edge shot areas ES patterns having substantially the same density as the patterns created on the normal shot areas NS by the first exposure system 1.

As an example, the pattern density of a mask is the ratio (i.e., the level of occupancy) of shaded portions formed per system area of the mask. In other words, the pattern density of a mask is the transmission factor of the pattern formation area on the mask relative to the exposure light. The pattern density of a mask (i.e., the transmission factor thereof) includes the average value of the transmission factor in the pattern formation area. Note that the pattern density of a mask may also be the ratio between shaded portions and light transmitting portions within a pattern formation area.

As an example, the pattern density of a substrate (i.e., the density of the patterns created in the shot areas of a substrate) is the ratio of those portions where exposure light is not irradiated per system area of the substrate. In other words, when the photosensitive film Rg is, for example, a positive type of film, the pattern density of the substrate is the proportion of those portions where a pattern (i.e., a recessed portion) is not formed per system area of the substrate. The pattern density of the substrate (i.e., the density of the pattern created in the shot areas) includes the average value of the proportion of those portions where exposure light was not irradiated per single shot area. Note that the pattern density of the substrate may also include the ratio between recessed portions and protruding portions with the shot areas on a substrate.

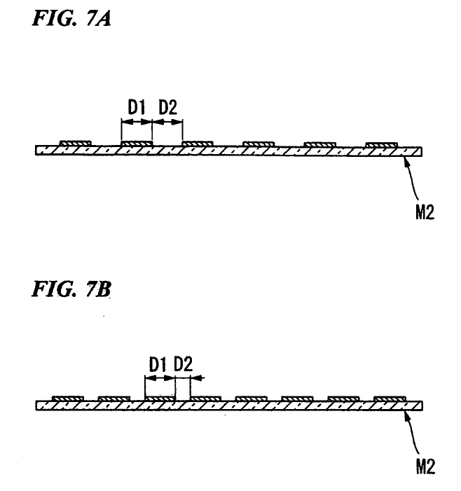

In one example, the pattern density of a mask can be altered by altering the ratio between a width D1 of the lines and a width D2 of the spaces of a line-and-space pattern. For example, as is shown in FIG. 7A, by setting the ratio between the width D1 of the lines (i.e., the shaded portions) and the width D2 of the spaces (i.e., the transmitting portions) of a line-and-space pattern formed on the mask M2 to 1:1, it is possible to set the pattern density of the second mask M2 to 50%. As is shown in FIG. 7B, by setting the ratio between the width D1 of the and the width D2 of the spaces of a line-and-space pattern formed on the mask M2 to 2:1, it is possible to set the pattern density of the second mask M2 to 67%.

Moreover, in the present embodiment, the second exposure system 2 creates on the edge shot areas ES patterns whose line width is larger than that of the patterns created on the normal shot areas NS by the first exposure system 1. If the line width of the patterns created on the normal shot areas NS is, for example, 65 nm to 500 nm, then patterns having a line width of, for example, 500 nm or more are created on the edge shot areas ES.

Next, an example of an operation of the exposure apparatus EX of the present embodiment will be described.

When a substrate P is transported from the coated developer apparatus CD to the exposure apparatus EX, the control apparatus 5 transports the substrate P which has been transported to the exposure apparatus EX to the temperature adjustment apparatus 3 using the transporting system 4. The temperature adjustment apparatus 3 adjusts the temperature of the substrate P before it is exposed by the first exposure system 1.

Using the transporting system 4, the control apparatus 5 then loads the substrate P whose temperature has been adjusted by the temperature adjustment apparatus 3 onto the first exposure system 1. The substrate P is held on the first substrate stage 6 of the first exposure system 1.

The control apparatus 5 then performs the detection of the positional information of the normal shot areas NS and the edge shot areas ES using the alignment system 17, and the measurement of the spatial image created by the first projection optical system PL1 using the spatial image measurement system 18, and also predetermined processing (including measurement processing and adjustment processing) such as EGA processing and the like. Thereafter, the control apparatus 5 exposes the normal shot areas NS on the substrate P which is being held on the first substrate stage 6 using the first exposure light L1 which has been shaped into a pattern by the first mask M1. The control apparatus 5 exposes the normal shot areas NS using the first exposure light L1 while adjusting the position of the substrate P such that the first exposure light L1 is not irradiated onto the edge shot areas ES.

The substrate P on which the normal shot areas NS have been exposed by the first exposure system 1 is unloaded from the first substrate stage 6 by the transporting system 4 and transported away from the first exposure system 1. The control apparatus 5 then transports the substrate P which has been transported away from the first exposure system 1 to the second exposure system 2.

In the present embodiment, the second exposure system 2 is placed either on or adjacent to the path along which the substrate P is transported from the first exposure system 1, and after the substrate P has been exposed by the first exposure system 1, the control apparatus 5 loads the substrate P onto the second substrate stage 8 of the second exposure system 2 using the transporting system 4. The second substrate stage 8 holds this substrate P.

Moreover, at a predetermined timing prior to exposing the edge shot areas ES of the substrate P, the control apparatus 5 loads a second mask M2 having substantially the same pattern density as the pattern density of the first mask M1 onto the second mask stage 20 using the transporting system 27. The second mask stage 20 holds the second mask M2.

Next, using the alignment system 25 of the second exposure system 2, the control apparatus 5 detects position information for the normal shot areas NS on the substrate P which is being held on the second substrate stage 8. While monitoring the position information of the second substrate stage 8 using the interferometer system 21, the control apparatus 5 detects the alignment marks formed on the substrate P which is being held on the second substrate stage 8 using the alignment system 25, and detects the position information of the normal shot areas NS within an XY plane stipulated by the interferometer system 21.

Moreover, using the focus and leveling detection system 24 of the second exposure system 2, the control apparatus 5 detects surface position information for the surface of the substrate P which is being held on the second substrate stage 8. The focus and leveling detection system 24 detects surface position information for at least the surface of the edge shot areas ES of the substrate P which is being held on the second substrate stage 8.

In the present embodiment, the positional relationship between the normal shot areas NS and the edge shot areas ES on a substrate P is determined, for example, by the first exposure system 1, and is already established. Moreover, the projection position of the image of the pattern created by the second projection optical system PL 2 within an XY plane stipulated by the interferometer system 21 (i.e., the position of the irradiation area PR 2 of the second exposure light L2) is also already established. Based on the position information for the normal shot areas NS detected using the alignment system 25, and on the positional relationship between the normal shot areas NS and the edge shot areas ES which is already established, and on the projection position information for the image of the pattern created by the second projection optical system PL2 which is also already established (i.e., the position information for the irradiation area PR2 of the second exposure light L2), the control apparatus 5 is able to adjust the positional relationship (i.e., the positional relationship in the X axial direction, the Y axial direction, and the θZ direction) between the normal shot areas NS and the edge shot areas ES relative to the irradiation area PR2 such that the second exposure light L2 is irradiated onto the edge shot areas ES and such that this second exposure light L2 is not irradiated onto the normal shot areas NS.

Moreover, based on detection results from the focus and leveling detection system 24, the control apparatus 5 is able to adjust the positional relationship (i.e., the positional relationship in the Z axial direction, the θX direction, and the θY direction) between the image plane of the second projection optical system PL2 and the surface of the edge shot areas ES on the substrate P which is being held on the second substrate stage 8.

Using the drive system 8D, the control apparatus 5 moves the second substrate stage 8 which is holding the substrate P, and thereby adjusts the positional relationship between the normal shot areas NS and the edge shot areas ES relative to the irradiation area PR2 of the second exposure light L2, and also the positional relationship between the image plane of the second projection optical system PL2 and the surface of the substrate P with the result that each one of the edge shot areas ES is exposed by the patterned second exposure light L2.

In order to expose the edge shot areas ES, the control apparatus 5 uses the adjustment mechanism 22 to adjust the illumination area IR2 on the second mask M2, and illuminates this adjusted illumination area IR2 on the second mask M2 with the second exposure light L2. The second exposure light L2 which has passed through the second mask M2 is shaped into patterns and is irradiated onto the edge shot areas ES of the substrate P via the second projection optical system PL2. As a result, an image of the patterns on the second mask M2 is projected onto the edge shot areas ES on the substrate P. The edge shot areas ES on the substrate P are exposed by the second exposure light L2 which has been shaped into patterns by the second mask M2 which has substantially the same pattern density as the pattern density of the first mask M1. Patterns having substantially the same density as that of the patterns created on the normal shot areas NS are thus created on the edge shot areas ES.

Moreover, in the present embodiment, when the second exposure system 2 is performing an operation to expose the edge shot areas ES on the substrate P with the second exposure light L2 which has been shaped into patterns, another substrate P is transported to the first exposure system 1, and the first exposure system 1 performs at least a portion of an operation to expose the normal shot areas NS of this substrate P with the first exposure light L1 which has been shaped into a pattern. In this manner, in the present embodiment, at least a portion of exposure operations to expose different substrates P are performed in parallel by the first exposure system 1 and the second exposure system 2.

The control apparatus 5 exposes the edge shot areas ES with the second exposure light L2 while moving relatively to each other the substrate P which is being held on the second substrate stage 8 and the second exposure light L2 which has been shaped into a pattern and is being emitted from the emission section 9 of the terminal optical element 23. In the present embodiment, when exposing a single edge shot area ES, the control apparatus 5 projects an image of the pattern on the second mask M2 onto the substrate P while moving the second mask M2 and the substrate P in synchronization with each other in the Y axial direction. The control apparatus 5 moves the substrate P in the Y axial direction relative to the irradiation area (i.e., the projection area of the second projection optical system PL2) PR2 of the second exposure light L2 which is emitted from the emission section 9 of the terminal optical element 23, and also moves the second mask M2 in the Y axial direction relative to the illumination area IR2 of the second illumination system IL2 in synchronization with the movement of the substrate P in the Y axial direction. At the same time as it does this, the control apparatus 5 irradiates the second exposure light L2 onto the substrate P via the second projection optical system PL2 so as to expose the edge shot areas ES of the substrate P with the second exposure light L2.

In the present embodiment, when exposing a plurality of the edge shot areas ES, the second exposure system 2 adjusts the relative positional relationship in the X axial direction between the substrate P and the irradiation area PR2 of the second exposure light L2.

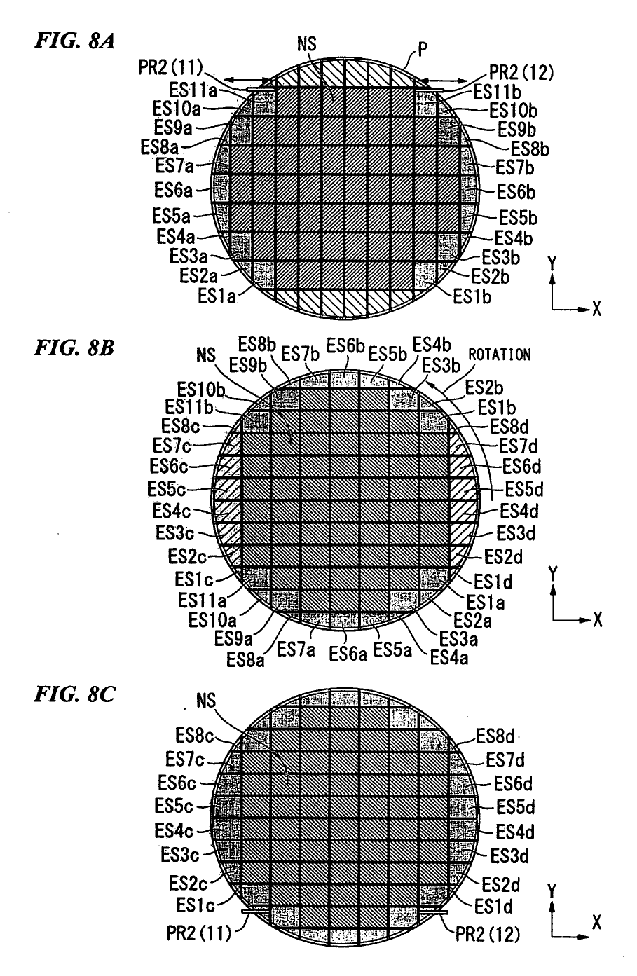

Next, an example of an operation to expose a plurality of edge shot areas ES will be described with reference made to the typical views shown in FIGS. 8A, 8B and 8C. FIGS. 8A-8C are a typical view showing relationships between the edge shot areas ES and the irradiation area PR2 of the second exposure light L2.

In the present embodiment, firstly, as is shown in FIG. 8A, a plurality of edge shot areas ES1a through ES11a which are arranged on the −X side of a plurality of normal shot areas NS (i.e., the effective exposure range) are exposed by the first exposure section 11, and a plurality of edge shot areas ES1b through ES11b which are arranged on the +X side of the plurality of normal shot areas NS (i.e., the effective exposure range) are exposed by the second exposure section 12. In the present embodiment, firstly, the edge shot areas (ES1a and ES1b) are exposed simultaneously by the first exposure section 11 and the second exposure section 22. After the edge shot areas (ES1a and ES1b) have been exposed, the edge shot areas (ES2a and ES2b) are exposed simultaneously by the first exposure section 11 and the second exposure section 22. Thereafter, in the same way, the edge shot areas (ES3a and ES3b) and the edge shot areas (ES4a and ES4b) down to the edge shot areas (ES11a and ES11b) are each exposed in sequence simultaneously.

For example, when exposing the edge shot areas (ES1a and ES11b), the control apparatus 5 uses the drive system 26 to adjust the relative positions in the X axial direction of the substrate P and the irradiation area PR2 of the first exposure section 11, and to also adjust the relative positions in the X axial direction of the substrate P and the irradiation area PR2 of the second exposure section 12. The relationship between the amount by which the drive system 26 is driven and the position of the irradiation area PR2 is already established, and based on measurement results for the drive amount of the drive system 26 measured using the measurement system 31, and on the relationship between the drive amount of the drive system 26 and the position of the irradiation area PR2 which is already established, the control apparatus 5 is able to determine the positional relationship between the edge shot areas ES on the substrate P and the irradiation area PR2. By driving the drive system 26 at the same time as it monitors measurement results from the measurement system 31, the control apparatus 5 adjusts the positional relationship in the X axial direction between the edge shot areas (ES1a and ES1b) of the substrate P and the first and second exposure sections 11 and 12 such that the second exposure light L2 is not irradiated onto the normal shot areas NS, and such that the second exposure light L2 is irradiated solely onto the edge shot areas (ES1a and ES1b).

In addition, after the control apparatus 5 has adjusted the position in the Y axial direction of the second substrate stage 8 such that the irradiation areas PR2 of the first and second exposure sections 11 and 12 are located at the scan exposure start positions of the edge shot areas (ES1a and ES1b), exposure of these edge shot areas (ES1a and ES1b) is started. When the driving of the drive system 26 has stopped, namely, when the positions of the irradiation areas PR2 of the first and second exposure sections 11 and 12 (i.e., the position of the terminal optical element 23 including the emission section 9) are substantially stationary, the control apparatus 5 moves the substrate P in the Y axial direction relative to the irradiation area PR2 of the second exposure light L2 emitted from the emission section 9 of the terminal optical element 23, and, in synchronization with this movement in the Y axial direction of the substrate P, exposes the edge shot areas (ES1a and ES1b) of the substrate P with the second exposure light L2 while moving the second mask M2 in the Y axial direction relative to the illumination area IR2 of the second illumination system IL2.

After the exposure of the edge shot areas (ES1a and ES1b) has ended, in order to perform the exposure of the edge shot areas (ES2a and ES2b), at the same time as it monitors measurement results from the measurement system 31 such that the second exposure light L2 is irradiated solely onto the edge shot areas (ES2a and ES2b), the control apparatus 5 drives the drive system 26 and moves the irradiation areas PR2 of the first and second exposure sections 11 and 12 in the X axial direction so as to adjust the positional relationships in the X axial direction between the edge shot areas (ES2a and ES2b) of the substrate P and the irradiation areas PR2 of the first and second exposure sections 11 and 12.

During the adjustment of the positional relationship in the X axial direction between the substrate P and the irradiation areas PR2, the emission of the second exposure light L2 from the emission section 9 is stopped. Namely, after the edge shot areas (ES1a and ES1b) have been exposed, during the adjustment of the positional relationship in the X axial direction between the substrate P and the irradiation areas PR2 prior to the exposure of the edge shot areas (ES2a and ES2b), the exposure of the edge shot areas (ES2a and ES2b) is stopped.

In addition, after adjusting the position in the Y axial direction of the second substrate stage 8 such that the irradiation areas PR2 of the first and second exposure sections 11 and 12 are placed at the scan exposure start positions of the edge shot areas (ES2a and ES2b), the control apparatus 5 starts the exposure of the edge shot areas (ES2a and ES2b). When the driving of the driving system 26 is stopped, namely, when the positions of the irradiation areas PR2 of the first and second exposure sections 11 and 12 are substantially stationary, the control apparatus 5 moves the substrate P in the Y axial direction to the irradiation area PR2 of the second exposure light L2 emitted from the emission section 9 of the terminal optical element 23, and also exposes the edge shot areas (ES2a and ES2b) of the substrate P while moving the second mask M2 to the illumination area IR2 of the illumination system IL2 in synchronization with the movement in the Y axial direction of this substrate P.

After the edge shot areas (ES2a and ES2b) have been exposed, in order to perform the exposure of the edge shot areas (ES3a and ES3b), the control apparatus 5 uses the drive system 26 to move the irradiation areas PR2 of the first and second exposure sections 11 and 12 in the X axial direction so as to adjust the positional relationships in the X axial direction between the edge shot areas (ES3a and ES3b) of the substrate P and the irradiation areas PR2 of the first and second exposure sections 11 and 12.

During the adjustment of the positional relationship in the X axial direction between the substrate P and the irradiation areas PR2, the emission of the second exposure light L2 from the emission section 9 is stopped.

In addition, after adjusting the position in the Y axial direction of the second substrate stage 8 such that the irradiation areas PR2 of the first and second exposure sections 11 and 12 are placed at the scan exposure start positions of the edge shot areas (ES3a and ES3b), the control apparatus 5 starts the exposure of these edge shot areas (ES3a and ES3b). When the positions of the irradiation areas PR2 are substantially stationary, the control apparatus 5 moves the substrate P in the Y axial direction to the irradiation areas PR2, and also exposes the edge shot areas (ES3a and ES3b) of the substrate P while moving the second mask M2 to the illumination area IR2 in synchronization with the movement in the Y axial direction of this substrate P.

Thereafter, the same operations as those described above are repeated in order to expose each of the edge shot areas (ES4a and ES4b), (ES5a and ES5b), . . . (ES11a and ES11b) with the second exposure light L2. Namely, the adjustment of the positional relationship in the X axial direction between the substrate P and the irradiation areas PR2, and the operation to move the substrate P in the X axial direction while the irradiation areas PR2 are kept substantially stationary and to then expose the edge shot areas ES with the second exposure light L2 are repeated until the exposure of the edge shot areas (ES11a and ES11b) has ended.

In the present embodiment, when the control apparatus 5 exposes the respective edge shot areas (ES1a and ES1b) to (ES11a and ES11b), the sizes, positions, and configurations of the illumination area IR2 and the irradiation area PR2 can be adjusted using the adjustment mechanism 22 in accordance with the size, position, and configuration of the respective edge shot areas (ES1a and ES1b) to (ES1a and ES11b).

Note that, here, when the irradiation area PR2 is substantially stationary, the substrate P is moved in the Y axial direction to the irradiation area IR2 and the respective edge shot areas ES are then exposed with the second exposure light L2, however, it is also possible, for example, to adjust the positional relationships in the X axial direction between the irradiation areas PR2 and the edge shot areas ES, and, once the second substrate stage 8 is substantially stationary, to then move the irradiation areas PR2 in the Y axial direction using the drive system 26 to the edge shot areas ES of the substrate P which is being held in a substantially stationary state on the second substrate stage 8. For example, when the edge shot areas (ES1a and ES1b) are being exposed, the control apparatus 5 moves the irradiation areas PR2 in the X axial direction using the drive system 26, and adjusts the positional relationship in the X axial direction between the irradiation areas PR2 and the edge shot areas (ES1a and ES1b) such that the second exposure light L2 is only irradiated onto the edge shot areas (ES1a and ES1b). After adjusting this positional relationship, the control apparatus 5 adjusts the position in the Y axial direction of the irradiation areas PR2 using the drive system 26 such that the irradiation areas PR2 are placed at the scan exposure start position of the edge shot areas (ES1a and ES1b). Next, the control apparatus 5 moves the irradiation areas PR2 in the Y axial direction to the substrate P using the drive system 26, and exposes the edge shot areas (ES1a and ES1b) of the substrate P using the second exposure light L2. Once the exposure of the edge shot areas (ES1a and ES1b) has ended, in order to perform the exposure of the edge shot areas (ES2a and ES2b), the control apparatus 5 moves the irradiation areas PR 2 in the X axial direction using the drive system 26, and adjusts the positional relationship in the X axial direction between the edge shot areas (ES2a and ES2b) of the substrate P and the irradiation areas PR2 such that the second exposure light L2 is irradiated only onto the edge shot areas (ES2a and ES2b). After adjusting this positional relationship, the control apparatus 5 adjusts the position in the Y axial direction of the irradiation areas PR2 using the drive system 26 such that the irradiation areas PR2 are placed at the scan exposure start position of the edge shot areas (ES2a and ES2b). Next, the control apparatus 5 moves the irradiation areas PR2 in the Y axial direction to the substrate P using the drive system 26, and exposes the edge shot areas (ES21a and ES2b) of the substrate P using the second exposure light L2. Thereafter, by performing the same operation, the edge shot areas (ES3a and ES3b) through (ES11a and ES11b) can be exposed.

Moreover, it is also possible to drive both the drive system 8D of the second substrate stage 8 and the drive system 26 of the first and second exposure sections 11 and 12, and thereby move both the substrate P and the irradiation areas PR2 in the Y axial direction, and then expose the edge shot areas on the substrate P with the second exposure light L2.

In this manner, it is possible to divide the exposure of the plurality of edge shot areas (ES1a and ES1b) through (ES11a and ES11b) on the substrate P into at least two operations which are performed in turn using the second exposure light L2 and, during these two or more exposure operations, to move the substrate P and the irradiation areas PR2 relatively to each other in a different direction from the direction in which they move during the exposure operations.

After the exposure of the plurality of edge shot areas (ES1a and ES1b) through (ES11a and ES11b) on the substrate P has ended, as is shown in FIG. 8B, the control apparatus 5 rotates the substrate P by a predetermined angle within an XY plane. In the present embodiment, the control apparatus 5 rotates the substrate P 90° within an XY plane. As a result, during the exposure of the edge shot areas (ES1a and ES1b) through (ES11a and ES11b), the plurality of edge shot areas ES1c through ES8c which were located on the +Y side of the normal shot areas NS (i.e., the effective exposure range) are placed on the −X side of the normal shot areas NS (i.e., the effective exposure range). In addition, during the exposure of the edge shot areas (ES1a and ES1b) through (ES1a and ES11b), the plurality of edge shot areas ES1d through ES8d which were located on the −Y side of the normal shot areas NS (i.e., the effective exposure range) are placed on the +X side of the normal shot areas NS (i.e., the effective exposure range). The edge shot areas ES1c through ES8c are exposed by the irradiation area PR2 created by the first exposure section 11, and the edge shot areas ES1d through ES8d are exposed by the irradiation area PR2 created by the second exposure section 12. In the present embodiment, firstly, the edge shot areas (ES1c and ES1d) are exposed simultaneously by the first exposure section 11 and the second exposure section 22. After the edge shot areas (ES1c and ES1d) has been exposed, the edge shot areas (ES2c and ES2d) are exposed simultaneously by the first exposure section 11 and the second exposure section 22. Thereafter, in the same way, the edge shot areas (ES3c and ES3d), (ES4c and ES4d), . . . (ES8c and ES8d) are each exposed simultaneously in sequence. Because the operation to expose the edge shot areas ES1c through ES8c and the edge shot areas ES1d through ES8d is the same as the above described operation to expose the edge shot areas ES1a through ES1a and the edge shot areas ES1b through ES 11b, a description thereof is omitted here. As a result of the edge shot areas ES1c through ES8c and the edge shot areas ES1d through ES8d being exposed, as is shown in FIG. 8C, the exposure of all of the shot areas ES on the substrate P is completed.

Once the exposure of the edge shot areas ES has ended, the control apparatus 5 transports this substrate P away from the second exposure system 2 using the transporting system 4. The substrate P which has been transported away from the second exposure system 2 is transported to the coater developer apparatus CD or to another apparatus, and various types of processing are performed thereon.

After the exposure of the substrate P, various types of processing such as, for example, developing processing, etching processing, and CMP processing are performed on the exposed substrate P. Although the edge shot areas ES do not function as a product, when patterns are formed on the normal shot areas NS, but are not formed on the edge shot areas ES, there is a possibility that a sizable height difference (i.e., step) will be created by the patterns between the normal shot areas NS and the edge shot areas ES. The consequence of this would be, for example, when CMP processing was being executed for what is known as shoulder touch phenomenon to occur. This would create the likelihood that it would not be possible to perform the CMP processing uniformly within the surface of the substrate P, and there is a possibility that defective chips would be created. Moreover, when patterns are formed on the normal shot areas NS, but are not formed on the edge shot areas ES, there is a possibility that it will not be possible to perform developing processing and etching processing and the like uniformly, and there is a possibility that defective chips would be created.

In the present embodiment, because the second exposure system 2 exposes the edge shot areas ES, it is possible to suppress the occurrence of defective chips. Moreover, because it is possible to provide the second exposure system 2 separately from the first exposure system 1 which exposes the normal shot areas NS, and execute the exposure of the edge shot areas ES of another substrate P in the second exposure system 2 in parallel with the exposure of the normal shot areas NS of the substrate P in the first exposure system 1, it is possible to suppress the occurrence of defective chips while also preventing any deterioration in throughput.

Moreover, in the present embodiment, patterns having substantially the same density as the patterns created on the normal shot areas NS are created on the edge shot areas ES. By creating patterns on the edge shot areas ES which have substantially the same density as the patterns created on the normal shot areas NS, it is possible to suppress any deterioration in uniformity in developing processing, etching processing, CMP processing and the like, and it is possible to suppress the occurrence of defective chips. Furthermore, even if patterns having a broader line width than that of the patterns created on the normal shot areas NS are created on the edge shot areas ES, by making the density of the patterns created on the normal shot areas NS the same as the density of the patterns created on the edge shot areas ES, it is possible to suppress any deterioration in uniformity in developing processing, etching processing, CMP processing and the like.

Even when the line width of the patterns created on the normal shot areas NS is, for example, approximately 65 nm, and the line width of the patterns created on the edge shot areas ES is, for example, approximately 500 nm, by making the pattern densities of the normal shot areas NS and the edge shot areas ES substantially the same, it is possible to suppress any deterioration in uniformity in developing processing, etching processing, CMP processing and the like.

Accordingly, even if the pattern creation accuracy (i.e., the exposure accuracy) for the edge shot areas ES is lower than the pattern creation accuracy (i.e., the exposure accuracy) for the normal shot areas NS, it is possible to suppress any deterioration in uniformity in developing processing, etching processing, CMP processing and the like, and it is possible to suppress the occurrence of defective chips. Namely, even if the pattern creation accuracy of the second exposure system 2 is lower than the pattern creation accuracy of the first exposure system 1, by making the pattern densities of the normal shot areas NS and the edge shot areas ES substantially the same, it is possible to suppress the occurrence of defective chips. Moreover, because the pattern creation accuracy (fineness, resolution, or the like) required from the second exposure system 2 is lower than the pattern creation accuracy required from the first exposure system 1, it is possible to suppress any increase in the apparatus costs of the second exposure system 2 and in manufacturing costs.

As has been described above, according to the present embodiment, because the second exposure system 2 which is used to expose the edge shot areas ES is provided separately from the first exposure system 1 which is used to expose the normal shot areas NS where chips can be formed, it is possible to form superior devices while suppressing any deterioration in throughput.

Moreover, by creating patterns on the edge shot areas ES which have substantially the same density as the patterns created on the normal shot areas NS, even if the patterns created on the normal shot areas NS and the patterns created on the edge shot areas ES are different such as having, for example, different line widths, it is possible to suppress any deterioration, for example, in uniformity in developing processing, etching processing, CMP processing and the like, and it is possible to form superior devices.

Note that in the present embodiment, the second exposure light L2 is irradiated simultaneously onto each one of two irradiation areas PR2 having different positions on the substrate P, however, it is also possible for this light to be irradiated separately (i.e., not simultaneously).

Note also that in the present embodiment, in order to expose the edge shot areas ES, the second exposure light L2 is irradiated onto two irradiation areas PR2, however, it is also possible, for example, to omit the second exposure section 12, and employ a single irradiation area PR2 to expose the edge shot areas ES. In this case, for example, after the control apparatus 5 has exposed the edge shot areas ES1a through ES11a using the first exposure section 11, it rotates the substrate P 90° within an XY plane, and then exposes the edge shot areas ES1c through ES8c. Thereafter, the control apparatus 5 rotates the substrate P 90° within an XY plane, and exposes the edge shot areas ES1b through ES1b using the first exposure section 11. It then rotates the substrate P 90° within an XY plane, and exposes the edge shot areas ES1d through ES8d. As a result, it is possible to expose all the edge shot areas ES on a substrate P using a single irradiation area PR2.

Note also that in the present embodiment, it is also possible to provide three or more irradiation areas PR2 in order to expose the edge shot areas ES. In the present embodiment, the first and second exposure sections 11 and 12 are located on both sides in the X axial direction of the center of the substrate P, however, it is also possible, for example, to provide third and fourth exposure sections on both sides in the Y axial direction of the center of the substrate P in addition to these first and second exposure sections 11 and 12, and to expose the edge shot areas ES using the second exposure light L2 which is emitted from each one of these four irradiation areas PR2.

Note that in the present embodiment, it is assumed that the projection position of the second projection optical system PL2 was already established, however, it is also possible to measure the projection position of the second projection optical system PL2 using a spatial image measurement system such as that disclosed in, for example, United States Patent Application Publication No. 2002/0041377 A, and to determine the projection position of the second projection optical system PL2 using the measurement results consequently obtained. In this case, the light receiving section (i.e., an optical component or a slit plate) of the spatial image measurement system is located in a movable component which may be placed, for example, on the image plane side of the second projection optical system PL2 such as the second substrate stage 8 or the like.

### Second Embodiment

A second embodiment will now be described. In the description given below, component elements which are the same as or equivalent to those of the above described embodiment are given the same symbols and any description thereof is either simplified or omitted.

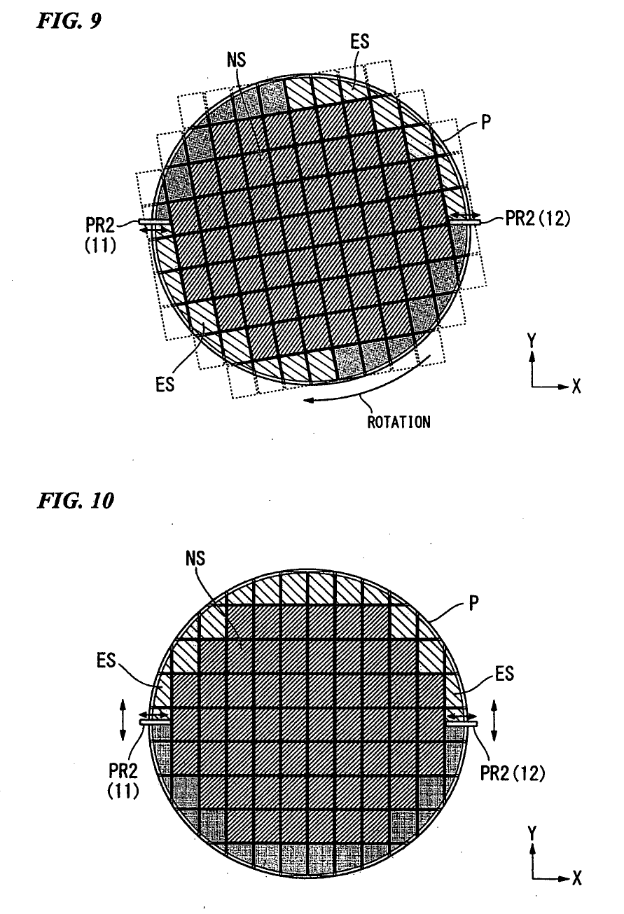

FIG. 9 is a typical view illustrating an example of an operation to expose a plurality of edge shot areas ES. The second exposure system 2 has first and second exposure sections 11 and 12, and is able to simultaneously irradiate the second exposure light L2 onto each one of two irradiation areas PR2 which are located at different positions on a substrate P. In the present embodiment, while rotating the substrate P which is being held on the second substrate stage 8 within an XY plane using the drive system 8D, the control apparatus 5 also moves the irradiation areas PR2 in the X axial direction (i.e., a radial direction relative to the rotation center of the substrate P) relative to a substrate P using the drive system 26, and exposes the edge shot areas ES using the second exposure light L2.

The control apparatus 5 exposes the edge shot areas ES using the second exposure light L2 while rotating the substrate P and also adjusting the positions in the X axial direction of the irradiation areas PR2 such that the second exposure light L2 is only irradiated onto the edge shot areas ES and is not irradiated onto the normal shot areas NS. The irradiation area PR2 of the first exposure section 11 and the irradiation area PR2 of the second exposure section 12 are located on both sides in the X axial direction of the rotation center of the substrate P, and by rotating the substrate P approximately 180°, the control apparatus 5 is able to expose all of the edge shot areas ES on the substrate P with the second exposure light L2.

In the present embodiment as well, excellent exposure of the edge shot areas ES can be obtained.

Note that in the present embodiment, the substrate P is rotated while the positions in the X axial direction of the irradiation areas PR2 are adjusted such that the second exposure light L2 is not irradiated onto the normal shot areas NS, however, it is also possible to hold the positions of the irradiation areas PR2 substantially stationary, and to move the substrate P in the X axial direction while rotating it such that the second exposure light L2 is not irradiated onto the normal shot areas NS. Moreover, while rotating the substrate P, it is also possible to move it in the X axial direction in parallel with the movement in the X axial direction of the irradiation areas PR2.

Note also that in the present embodiment, the second exposure light L2 is irradiated simultaneously onto each one of two irradiation areas PR2 having different positions on the substrate P, however, it is also possible for this light to be irradiated separately (i.e., not simultaneously).

Note also that in the present embodiment, it is also possible, for example, to omit the second exposure section 12 and employ a single irradiation area PR2 to expose the edge shot areas ES. In this case, by rotating the substrate P approximately 360°, the control apparatus 5 is able to expose all the edge shot areas ES on a substrate P with the second exposure light L2. Moreover, it is also possible to provide three or more irradiation areas PR2 in order to expose the edge shot areas ES.

### Third Embodiment

A third embodiment will now be described. In the description given below, component elements which are the same as or equivalent to those of the above described embodiment are given the same symbols and any description thereof is either simplified or omitted.

FIG. 10 is a typical view illustrating an example of an operation to expose a plurality of edge shot areas ES. The second exposure system 2 has first and second exposure sections 11 and 12, and is able to simultaneously irradiate the second exposure light L2 onto each one of two irradiation areas PR2 which are located at different positions on a substrate P. In the present embodiment, using at least one of the drive system 8D and the drive system 26, the control apparatus 5 moves the substrate P and the irradiation areas PR2 relatively to each other in both the X axial direction and the Y axial direction, and exposes the edge shot areas ES using the second exposure light L2.

For example, while holding the substrate P substantially stationary, the control apparatus 5 exposes the edge shot areas ES using the second exposure light L2 while adjusting the positions in the X axial direction and in the Y axial direction of the irradiation areas PR2 such that the second exposure light L2 is only irradiated onto the edge shot areas ES and is not irradiated onto the normal shot areas NS.

Moreover, while adjusting the positions in the X axial direction of the irradiation areas PR2 and while moving the substrate P in the Y axial direction, the control apparatus 5 exposes the edge shot areas ES using the second exposure light L2 such that the second exposure light L2 is only irradiated onto the edge shot areas ES and is not irradiated onto the normal shot areas NS.

In the present embodiment as well, excellent exposure of the edge shot areas ES can be obtained.

Note that in the present embodiment as well, it is also possible for either one or three or more irradiation areas PR2 to be employed.

### Fourth Embodiment

A fourth embodiment will now be described. In the description given below, component elements which are the same as or equivalent to those of the above described embodiment are given the same symbols and any description thereof is either simplified or omitted. The characteristic portion of the present embodiment is the fact that there is provided a movable apparatus 32 which is able to move while holding a plurality of second masks M2 which at least have different pattern densities.

FIG. 11 is a typical view illustrating an example of a first exposure section 11B (or a second exposure section 12B) according to the present embodiment. In FIG. 11, the first exposure section 11B is provided with a movable apparatus 32 which is able to move while holding a plurality of the second masks M2 which have different pattern densities. The movable apparatus 32 is provided with a holding component 33 which holds the plurality of second masks M2, and with a drive apparatus 34 which moves this holding component 33.

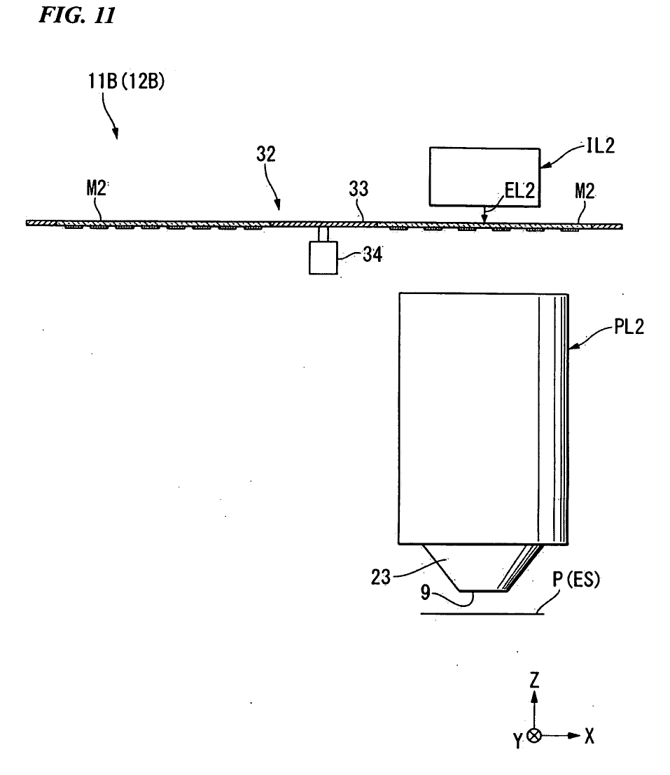

FIG. 12 is a plan view showing the holding component 33 holding a plurality of second masks M2. As is shown in FIG. 12, in the present embodiment, the outer shape of the holding component 33 is circular. In the present embodiment, the holding component 33 holds four second masks M2. The four second masks M2 are positioned at substantially equal intervals peripherally to the center of the holding component 33. Each of the second masks M2 has a different pattern density to the others.

The drive apparatus 34 rotates the holding component 33 within an XY plane. As a result of the holding component 33 being rotated, one second mask M2 from among the plurality of second masks M2 is placed at the irradiation position of the second exposure light L2 which is emitted from the second illumination system IL2. The control apparatus 5 exchanges the second mask M2 at the irradiation position of the second exposure light L2 in accordance with the pattern to be created on the normal shot areas NS. The control apparatus 5 selects a predetermined second mask M2 from among the plurality of second masks M2 held on the holding component 33 so as to enable patterns having substantially the same density as the patterns being created on the normal shot areas NS to be created on the edge shot areas ES, and, using the drive apparatus 34, rotates the holding component 33 such that the selected second mask M2 is placed at the irradiation position of the second exposure light L2.

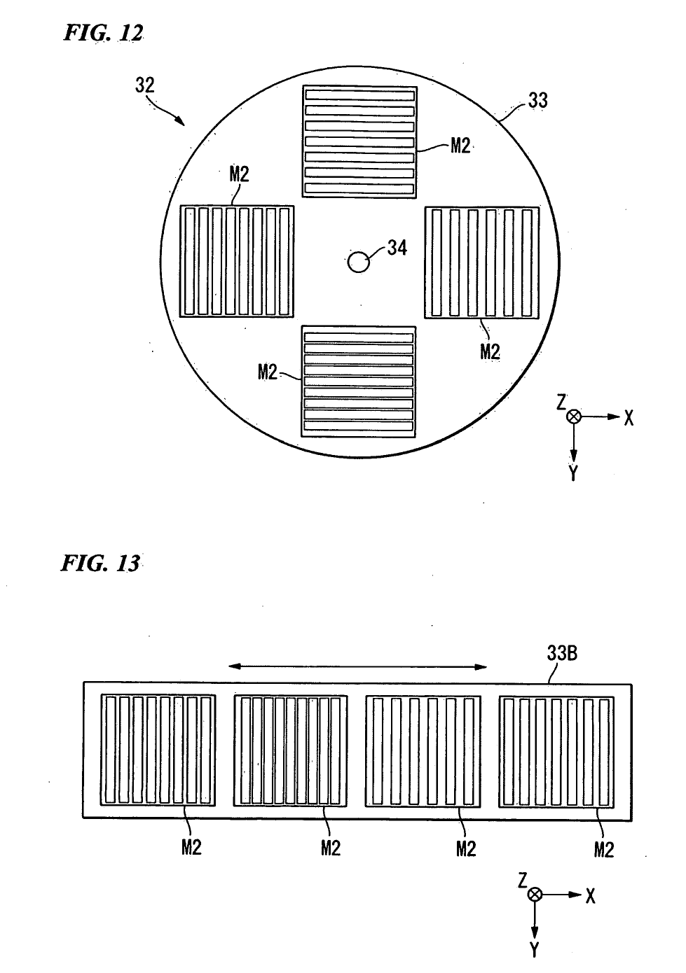

Note that, as is shown in FIG. 13, it is also possible for the outer shape of a holding component 33B to be rectangular within an XY plane. The holding component 33B shown in FIG. 13 holds a plurality of the second masks M2 such that these second masks M2 are aligned in the X axial direction. The holding component 33 B is able to move by means of a predetermined drive apparatus (not shown) in the X axial direction relative to the irradiation position of the second exposure light L2 which is emitted from the second illumination system IL2. The control apparatus 5 selects a predetermined second mask M2 from among the plurality of second masks M2 held on the holding component 33B so as to enable patterns having substantially the same density as the patterns being created on the normal shot areas NS to be created on the edge shot areas ES, and moves the holding component 33B such that the selected second mask M2 is placed at the irradiation position of the second exposure light L2.

In the present embodiment as well, it is possible to alter the patterns being created on the edge shot areas ES in accordance with the patterns being created on the normal shot areas NS.

### Fifth Embodiment

A fifth embodiment will now be described. In the description given below, component elements which are the same as or equivalent to those of the above described embodiment are given the same symbols and any description thereof is either simplified or omitted.

In the above described first through fourth embodiments, the second exposure system 2 is provided with a second projection optical system PL2 which projects an image of the second mask M2 onto a substrate P, however, it is also possible to employ a method in which no projection optical system is used. Even if a projection optical system is not used, it is still possible to irradiate the second exposure light L2 onto a substrate P.

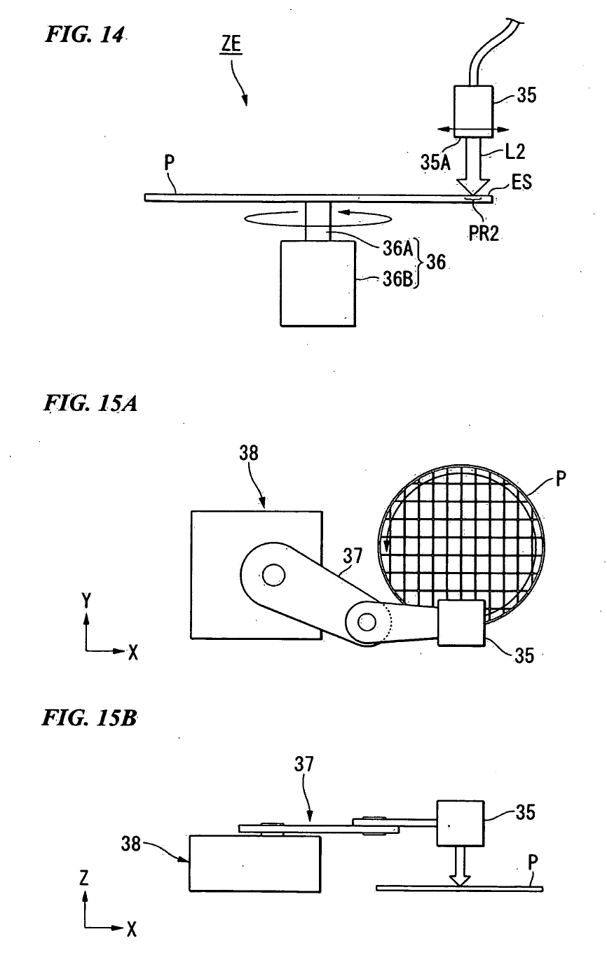

For example, as is shown in FIG. 14, a second exposure system 2E is able to expose the edge shot areas ES using an illumination apparatus 35 which is able to emit second exposure light L2 which has been shaped into a pattern. ArF excimer laser light which is emitted from a light source apparatus (such as a laser apparatus—not shown) is supplied via a light guiding component such as an optical fiber to the illumination apparatus 35. The illumination apparatus 35 also emits the second exposure light L2 from an emission surface 35A via predetermined optical components (i.e., lenses and the like). In the present embodiment, an aperture pattern which is used to provides a pattern to the second exposure light L2 is provided on the emission surface 35A. The illumination apparatus 35 is smaller than the substrate P and is able to move smoothly relative to the substrate P.

The second exposure system 2E shown in FIG. 14 is provided with a rotation apparatus 36 which is able to rotate a substrate P. The rotation apparatus 36 includes a turntable 36A which rotatably holds a substrate P, and a drive apparatus 36B which causes the turntable 36A to rotate. The second exposure system 2E exposes the edge shot areas ES by moving the irradiation area PR2 of the illumination apparatus 35 within an XY plane while causing the substrate P to rotate using the rotation apparatus 36.

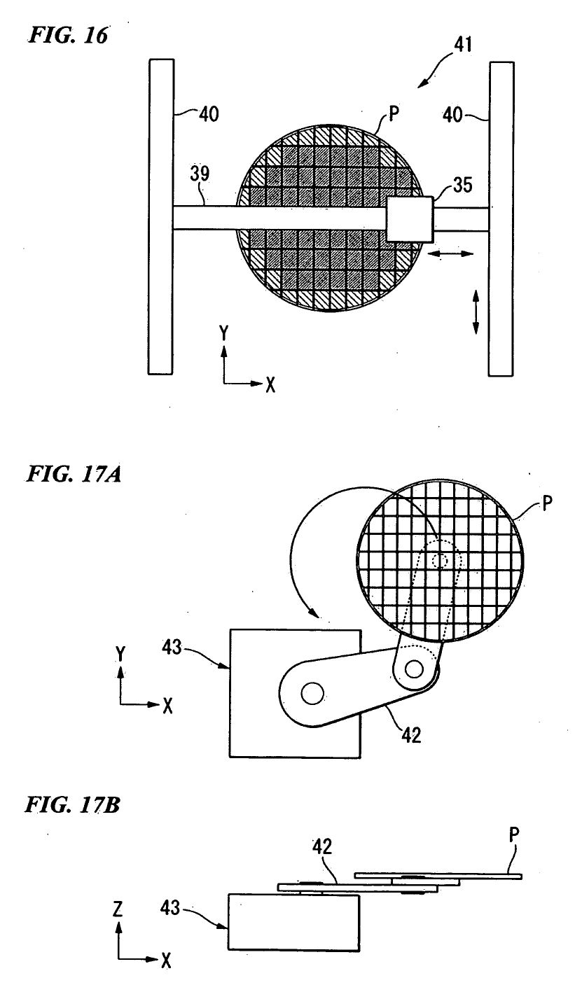

The illumination apparatus 35 is able to be moved by a drive apparatus 38 which has a robot arm 37 such as that shown in FIGS. 15A and 15B. The illumination apparatus 35 is also able to be moved by a drive apparatus 41 such as that shown in FIG. 16 which includes an X guide component 39 which is elongated in the X axial direction, and Y guide components 40 which are elongated in the Y axial direction and are located at both ends of the X guide component 39. The X guide component 39 includes a stator of a linear motor, while a slider thereof is able to move in the X axial direction along the X guide component 39 while holding the substrate P. The Y guide components 40 include a stator of a linear motor, and are able to move the X guide component 39 which is connected to the slider of this linear motor in the Y axial direction. The illumination apparatus 35 can be moved within an XY plane relative to the substrate P by the drive apparatus 38 or the drive apparatus 14.

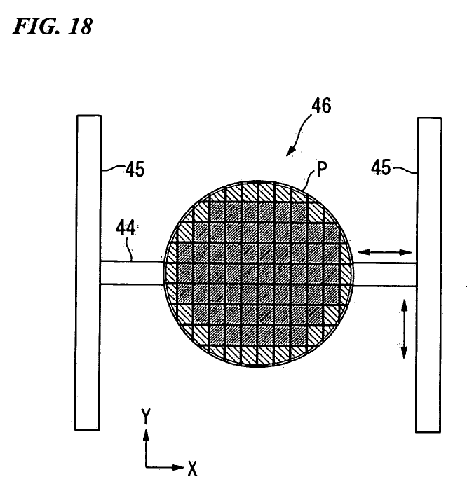

Moreover, as is shown in FIGS. 17A and 17B, it is also possible for the substrate P to be driven by a drive apparatus 43 having a robot arm 42, or, as is shown in FIG. 18, for the substrate P to be driven by a drive apparatus 46 which includes an X guide component 44 which is elongated in the X axial direction, and Y guide components 45 which are elongated in the Y axial direction and are located at both ends of the X guide component 44.

Moreover, in each of the above described embodiments, it is possible to expose the edge shot areas ES by moving the substrate P and the irradiation areas PR2 respectively in different optional directions within an XY plane. For example, it is also possible to expose the edge shot areas ES while moving at least one of the substrate P and the irradiation areas PR2 in directions which are diagonal to the X axis and the Y axis instead of using the X axial direction and the Y axial direction.

Moreover, the irradiation area PR2 of the second exposure light L2 is not limited to being a slit shape which is elongated in the X axial direction, and may also be a size and shape which correspond to the size and shape of the edge shot areas ES.

Furthermore, for the second exposure system 2, in addition to using a scanning exposure method (i.e., a step-and-scan method) in which the edge shot areas ES are exposed using the second exposure light L2 by moving the substrate P and the irradiation area PR2 of the second exposure light L2 relatively to each other, it is also possible to use a collective exposure method (i.e., a step-and-repeat method) in which the edge shot areas ES are exposed by the patterned second exposure light L2 with the substrate P in a substantially stationary state. For the first exposure system 1 as well, in addition to using a scanning exposure method (i.e., a step-and-scan method) in which the patterns on a first mask M1 are scan-exposed by moving the first mask M1 and the substrate P in synchronization, it is also possible to use a collective exposure method (i.e., a step-and-repeat method) in which, with the first mask M1 and the substrate P in a substantially stationary state, the patterns on the first mask M1 are collectively exposed onto each of the normal shot areas NS while the substrate P is moved in sequential steps.

Moreover, in an exposure performed using a collective exposure method, it is also possible to perform a collective exposure (i.e., using a stitch type of collective exposure apparatus) in which, with a first pattern and a substrate P in a substantially stationary state, a reduced-size image of the first pattern is first transferred onto the substrate P using a projection optical system (i.e., the first projection optical system PL1 or the second projection optical system PL2), and then, with a second pattern and the substrate P in a substantially stationary state, a reduced-size image of the second pattern is transferred using a projection optical system onto the substrate P such that it partially overlaps the first pattern. Moreover, for the stitch type of exposure apparatus, it is also possible to use a step-and-stitch type of apparatus which transfers at least two patterns onto a substrate P such that they partially overlap each other, and then sequentially moves the substrate P.

Furthermore, it is also possible for at least one of the first exposure system 1 and the second exposure system 2 to be a type of apparatus such as that described in, for example, U.S. Pat. No. 6,611,316 which synthesizes the patterns of two masks on a substrate P via a projection optical system (i.e., the first projection optical system PL1 or the second projection optical system PL2), and then performs a double exposure substantially simultaneously of a single shot area (i.e., a normal shot area NS or an edge shot area ES) on the substrate P via a single scan exposure. It is also possible for at least one of the first exposure system 1 and the second exposure system 2 to be a proximity type of exposure apparatus, or to be a mirror projection aligner or the like.

Moreover, in each of the above described embodiments, a transparent mask that is obtained by forming a predetermined light-shielding pattern (or a phase pattern or light-reducing pattern) on an optically transparent substrate is used for the first and second masks M1 and M2, however, instead of this mask, as is disclosed, for example, in U.S. Pat. No. 6,778,257, it is also possible to use a variable mold mask (also known as an electronic mask, an active mask, or an image generator) that forms a transmission pattern or a reflection pattern or a light-emission pattern based on electronic data for the pattern to be exposed. Variable mold masks include, for example, DMD (digital micro-mirror devices) which are a type of non-emission image display element (i.e., spatial optical modulator). Furthermore, the variable mold mask is not limited to being a DMD, and instead of a DMD is also possible to use the non-emission image display element described below. Here, a non-emission image display element is an element which spatially modulates the amplitude (i.e., intensity), phase, or polarization state of light which is advancing in a predetermined direction, and examples of a transmission type of spatial optical modulator include an electrochromic display (ECD) in addition to a transmission type of liquid crystal display element (LCD). Moreover, in addition to the aforementioned DMD, examples of a reflective type of spatial optical modulator include a reflective mirror array, a reflective liquid crystal display element, an electro phonetic display (EPD), electronic paper (or electronic ink), and a grating light valve.

The second exposure system 2 varies the patterns (i.e., the pattern density) which are created on the edge shot areas ES using a variable mold mask. As a result, it is possible to smoothly create patterns having substantially the same density as the patterns created in the normal shot areas NS in the edge shot areas ES.

Moreover, instead of a variable mold mask which is provided with a non-emission image display element, it is also possible for it to be provided with a pattern formation apparatus which includes a self-luminous image display element. In this case, an illumination system is not required. Here, examples of the self-luminous image display element include a CRT (i.e., a cathode ray cube), and inorganic EL display, an organic EL display (i.e., an OLED: organic light emitting diode), an LED display, an LD display, an FED (i.e., a field emission display), and a PDP (i.e., a plasma display panel). Furthermore, as the self-luminous image provided in the pattern formation apparatus, it is possible to use a solid state light source chip having a plurality of light emitting points, a solid state light source chip array in which a plurality of individual chips are arranged in an array formation, or a type in which a plurality of light emitting points are created on a single substrate, and to form a pattern by electrically controlling the relevant solid state light source chip. Note that the solid state light source element may be either inorganic or organic.

It is also possible to employ a method such as that disclosed, for example, in PCT International Publication No. WO 2001/035168 in which at least one of the first exposure system 1 and the second exposure system 2 forms interference fringes on a substrate P, so that a line-and-space pattern is created on the substrate P.

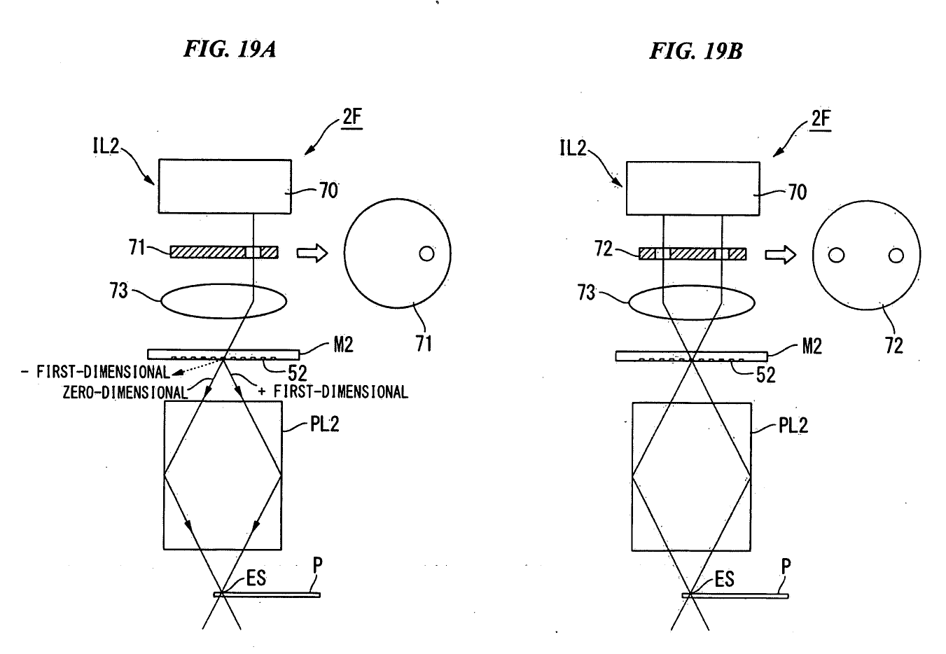

FIGS. 19A and 19B shows an example of a second exposure system 2F which exposes the edge shot areas ES using interference fringes. In FIG. 19 (A), a monopolar illumination diaphragm 71 which has a single aperture located at a position offset from the optical axis is placed downstream on the optical path of a light source 70 of the second illumination system IL2. Light beams emitted from the light source 70 pass through the aperture of the monopolar illumination diaphragm 71, and then pass through a lens system 73, and are obliquely irradiated onto an L/S pattern 52 of the second mask M2. Of the zero-dimensional light and the ±first-dimensional light diffracted by the L/S pattern 52 of the second mask M2, only the zero-dimensional light and the +first-dimensional light (or else the −first-dimensional light) are irradiated into the second projection optical system PL2. The edge shot areas ES of the substrate P are exposed via a two-light beam interference method which is based on the zero-dimensional light and the +first-dimensional light (or else the −first-dimensional light). Alternatively, as is shown in FIG. 19B, it is also possible to perform the exposure using a dipolar illumination diaphragm 72 which has two apertures located at positions offset from the optical axis. Alternatively, it is also possible to use a quadropolar illumination diaphragm which has four apertures. Altering the illumination conditions is not limited to simply altering the diaphragm, and the zoom optical system and diffraction optical elements and the like may also concomitantly or alternatively be used.

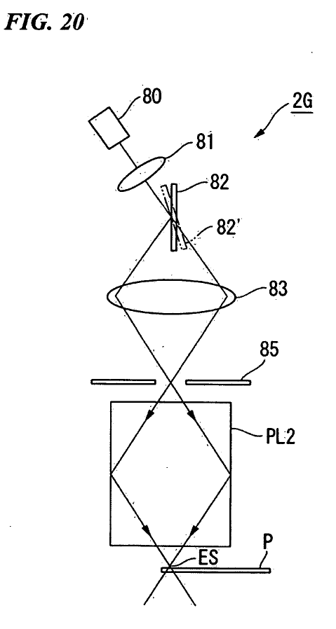

FIG. 20 shows an example of a second exposure system 2G which exposes the edge shot areas ES using interference fringes. In FIG. 20, a first lens system 81 which includes a collimator lens, a half mirror 82 which splits the light beams which have passed through the first lens system 81 into two light beam groups, a second lens system 83, and an aperture diaphragm 85 are provided downstream on the optical path of a light source 80 which is able to emit coherent light such as laser light or the like. The light beams emitted from the light source 80 pass through the first lens system 81, and are split into two light beam groups by the half mirror 82. These two light beam groups are then irradiated into the second projection optical system PL2 via the second lens system 83. An interference fringe pattern is formed in the edge shot areas ES of the substrate P via a two-light beam interference method based on the two light beam groups. In this manner, it is possible to expose the edge shot areas ES without using a pattern (i.e., the second mask M2).

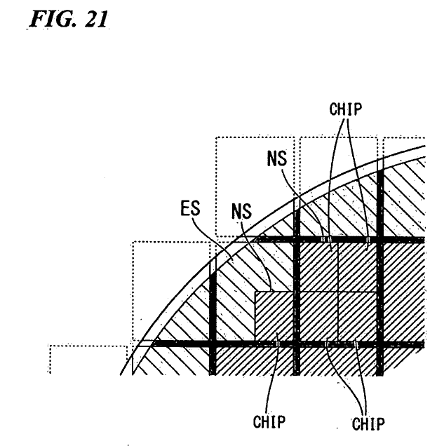

Note that, in each of the above described embodiments, a single chip is placed in each individual normal shot area NS, however, as is shown in FIG. 21, it is also possible for a plurality of chips to be placed in each individual normal shot area NS. In this case, an edge shot area ES can be applied to a shot area in which at least one chip is not existed on the substrate P (inside the effective exposure range), or to a shot area in which any chips is not existed on the substrate P (inside the effective exposure range). In the former, chip(s) located inside the effective exposure range can be exposed with the first exposure light and the other chip(s) (at least a portion thereof protruding from the effective exposure range) can be exposed with the second exposure light.

Moreover, it is also possible for a different number of chips to be formed in each one of a plurality of normal shot areas NS. For example, one chip having a first size may be formed in a first normal shot area NS, while, for example, four chips having a second size which is smaller than the first size may be formed in a second normal shot area NS. It is also possible for the size of the formed chips to be mutually different from each other. In the case shown in FIG. 21 as well, the second exposure system 2 exposes areas on a substrate P where chips are not formed with the second exposure light L2.

Note that, in each of the above described embodiments, an example is described in which the second exposure system 2 exposes the edge shot areas ES located between the normal shot areas NS and the edge of the substrate P with the second exposure light L2, however, if, for example, an area where no chip is to be formed has been set in a portion within the effective exposure range in the vicinity of the center of the surface of a substrate P, then the second exposure system 2 can expose this portion within the effective exposure range using the second exposure light L2.

Moreover, in each of the above described embodiments, the edge shot areas ES are smaller than the normal shot areas NS, however, even if they are larger than the normal shot areas NS (i.e., when it is possible for a chip to be placed thereon), as a result of the second exposure system 2 exposing these edge shot areas ES with the second exposure light L2, it is possible to suppress the occurrence of defective chips.

Note that, in each of the above described embodiments, the second exposure system 2 exposes the edge shot areas ES of a substrate P after the normal shot areas NS have first been exposed by the first exposure system 1, however, it is also possible for the edge shot areas ES of a substrate P to be exposed before this substrate P has been exposed by the first exposure system 1. Namely, it is also possible for the control apparatus 5 to expose the normal shot areas NS of a substrate P using the first exposure system 1 after it has exposed the edge shot areas ES of this substrate P using the second exposure system 2. In this case, the control apparatus 5 exposes the substrate P with the second exposure light L2 in the second exposure system 2 before the temperature thereof is adjusted by the temperature adjustment apparatus 3. Namely, the control apparatus 5 transports a substrate P which has been transported from the coater developer apparatus CD to the exposure apparatus EX to the second exposure system 2 using the transporting system 4, and then exposes the edge shot areas ES of this substrate P using the second exposure system 2. In this case, the second exposure system 2 is located either on or adjacent to the transporting path of the substrate P from the coater developer apparatus CD to the first exposure system 1. As a result, the transporting system 4 is able to transport a substrate P to the second exposure system 2 prior to this substrate P being exposed.

In addition, after the exposure by the second exposure system 2 has ended, the control apparatus 5 transports the substrate P whose edge shot areas ES have been exposed by the second exposure system 2 away from the second exposure system 2 using the transporting system 4, and transports it to the holding component 19 of the temperature adjustment apparatus 3. The temperature adjustment apparatus 3 adjusts the temperature of the arriving substrate P. Next, after the temperature adjustment performed by the temperature adjustment apparatus 3 has ended, the control apparatus 5 transports the substrate P away from the temperature adjustment apparatus 3, and transports it to the first exposure system 1. The normal shot areas NS of the substrate P which has been transported to the first exposure system 1 are then exposed by the first exposure system 1.

As a result of the edge shot areas ES of the substrate P being exposed by the second exposure light L2, and the temperature of this substrate P then being adjusted by the temperature adjustment apparatus 3, and the normal shot areas NS then being exposed by the first exposure light L1, it is possible to form a superior pattern on the normal shot areas NS of a substrate P which has already been adjusted to a desired temperature.

Note that in each of the above described embodiments, a single light source (here, an ArF excimer laser device) is used commonly for the light source of both the first exposure system 1 and the second exposure system 2.

Note also that in each of the above described embodiments, an example is described in which the first and second exposure lights L1 and L2 are both excimer laser lights, however, it is also possible to use another wavelength such as, for example, emission rays (i.e., g-rays, h-rays, and i-rays) emitted from a mercury lamp and KrF excimer laser light (having a wavelength of 248 nm). Moreover, provided that it is possible to form a pattern on a photosensitive film Rg with the desired accuracy, then it is also possible for the wavelength of the first exposure light L1 to be different from the wavelength of the second exposure light L2.

Note also that in each of the above described embodiments, a case is described in which the second exposure system 2 is provided in the exposure apparatus EX, however, it is also possible for it to be provided, for example, in the coater developer apparatus CD, or in the interface IF. Alternatively, the exposure apparatus EX and the coater developer apparatus CD may be placed in separate apparatuses and locations. Namely, it is not absolutely essential for the second exposure system (i.e., exposure apparatus) which is used to expose the edge shot areas ES to be provided in the exposure apparatus EX, and it may also be provided in another apparatus.

Note also that in each of the above described embodiments, it is also possible for at least one of the first exposure system 1 and the second exposure system 2 to be an immersion exposure type apparatus which exposes a substrate using exposure light via a liquid medium such as that disclosed, for example, in PCT International Publication No. WO 99/49504.

Note also that the substrate P in each of the above described embodiments is not limited to being a semiconductor wafer which is used for manufacturing semiconductor devices, and glass substrates used for display devices, ceramic wafers used for thin-film magnetic heads, and original plates (i.e., synthetic quartz or silicon wafers) of masks or reticles used in exposure apparatuses, and the like may also be used.

Moreover, as the exposure apparatus EX, it is also possible to use a twin-stage type of exposure apparatus which is provided with a plurality of substrate stages such as those disclosed in U.S. Pat. No. 6,341,007, U.S. Pat. No. 6,400,441, U.S. Pat. No. 6,549,269, U.S. Pat. No. 6,590,634, U.S. Pat. No. 6,208,407, and U.S. Pat. No. 6,262,796 and the like.

Furthermore, the present invention can also be applied to an exposure apparatus which is provided with a substrate stage which holds a substrate, and with a measurement stage on which reference components on which reference marks are formed and/or various photo electronic sensors are mounted such as those disclosed in U.S. Pat. No. 6,897,963 and European Patent Application Publication No. 1,713,113. Moreover, it is also possible to employ an exposure apparatus which is provided with a plurality of substrate stages and measurement stages.

The type of exposure apparatus is not limited to an exposure apparatus for manufacturing semiconductor elements which exposes a semiconductor element pattern on a substrate P, and the present invention can also be applied to a broad range of exposure apparatuses such as exposure apparatuses for manufacturing liquid cry stal display elements or for manufacturing displays or the like, and exposure apparatuses for manufacturing thin-film magnetic heads, image pickup devices (CCD), micromachines, MEMS, DNA chips, and masks and reticles and the like.

Note also that in each of the above described embodiments, the respective positional information of each stage is measured using an interferometer system which includes a laser interferometer, however, the present invention is not limited to this and it is also possible to use, for example, an encoder system which detects a scale (i.e., a diffraction grating) which is provided on each stage. In this case, it is preferable to employ a hybrid system which is provided with both an interferometer system and an encoder system, and to calibrate measurement results from the encoder system using measurement results from the interferometer system. In addition, it is also possible to perform positional control of a stage while switching between using an interferometer system and an encoder system, or to use both systems.

Moreover, in each of the above described embodiments, an ArF excimer laser is used as the light source apparatus which emits ArF excimer laser light for the exposure light EL, however, it is also possible to use, for example, a solid-state laser light source such as a DFB semiconductor laser or a fiber laser such as is disclosed in U.S. Pat. No. 7,023,610, or a higher harmonic wave generating apparatus which includes an optical amplification portion having a fiber amp or the like and a wavelength conversion portion, and which outputs pulse light having a wavelength of 193 nm. Furthermore, in the above described embodiments, both the respective illumination areas and the respective irradiation areas (i.e., projection areas) are each formed in a rectangular shape, however, it is also possible to use other shapes such as, for example, a circular arc shape or the like.

As is described above, the light source apparatus of the embodiments of the present application is manufactured by assembling various subsystems which include the respective component elements such that they have a predetermined mechanical accuracy, electrical accuracy and optical accuracy. In order to secure these levels of accuracy, both before and after the assembly steps, adjustments to achieve optical accuracy in the various optical systems, adjustments to achieve mechanical accuracy in the various mechanical systems, and adjustments to achieve electrical accuracy in the various electrical systems are made. The assembly step to assemble an exposure apparatus from the various subsystems includes making mechanical connections, electrical circuit wiring connections, and air pressure circuit tube connections and the like between the various subsystems. Prior to the assembly step to assemble an exposure apparatus from the various subsystems, it is of course necessary to perform assembly steps to assemble the respective individual subsystems. Once the assembly step to assemble an exposure apparatus from the various subsystems has ended, comprehensive adjustments are made so as to secure various levels of accuracy in the exposure apparatus as a whole. Note that it is desirable for the manufacturing of the exposure apparatus to be conducted in a clean room in which temperature and cleanliness and the like are controlled.

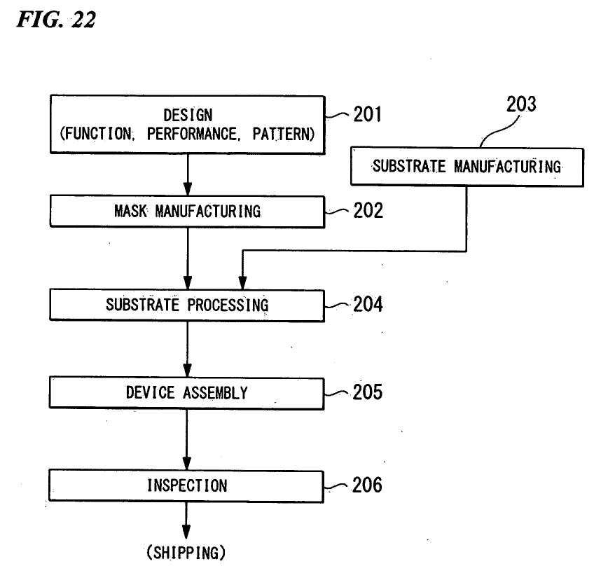

As is shown in FIG. 22, a micro device such as a semiconductor device is manufactured via a step 201 in which the functions and performance of the micro device are designed, a step 202 in which a mask (i.e., a reticle) that is based on the design step is manufactured, a step 203 in which a substrate that forms the base material of the device is manufactured, a substrate processing step 204 that includes substrate processing (i.e., exposure processing) in which a substrate is exposed with exposure light using an image of a pattern on the mask and the exposed substrate is then developed, a device assembly step (including working processes such as a dicing step, a bonding step, a packaging step and the like) 205, and an inspection step 206. The cleaning operation of the above described embodiments is included in the substrate processing step 204.

Note that various combinations of the essential elements of each of the above described embodiments can be made in order to meet requirements. In addition, all of the documents and disclosures in US patents relating to exposure apparatuses and the like that are cited in each of the above described embodiments and variant examples thereof have been invoked and used as a portion of the present document.

1. An exposure apparatus that exposes a substrate, comprising:
a first exposure system that drives a movable component which holds the substrate, and that, using patterned first exposure light, exposes a first shot area where a chip which is used to create a device can be formed on the substrate; and
a second exposure system that comprises a holding component which is different from the movable component and is able to hold the substrate, and that, while relative movement between the substrate and patterned second exposure light, exposes a second shot area where the chip is not to be formed on the substrate using the second exposure light.

2. The exposure apparatus according to claim 1, wherein the second exposure system comprises a modification apparatus by which a pattern created on the second shot area can be modified.

3. An exposure apparatus that exposes a substrate, comprising
a first exposure system that, using patterned first exposure light, exposes a first shot area where a chip which is used to create a device can be formed on the substrate; and
a second exposure system that exposes a second shot area where the chip is not to be formed on the substrate using the second exposure light, and by which a pattern created on the second shot area can be modified.

4. The exposure apparatus according to claim 2, wherein, in accordance with the pattern created on the first shot area by the first exposure system, the second exposure system modifies the pattern to be created on the second shot area.

5. The exposure apparatus according to claim 2, wherein at least a density of the pattern can be modified by the second exposure system.

6. The exposure apparatus according to claim 1, wherein the second exposure system creates in the second shot area a pattern having substantially the same density as that of the pattern created in the first shot area by the first exposure system.

7. The exposure apparatus according to claim 1, wherein the second exposure system provides a pattern to the second exposure light using a mask.

8. The exposure apparatus according to claim 7, wherein the second exposure system comprises a projection optical system that projects an image of the mask onto the substrate.

9. The exposure apparatus according to claim 8, further comprising:
a first adjustment apparatus that adjusts a positional relationship between an image plane of the projection optical system and a surface of the substrate.

10. The exposure apparatus according to claim 9, further comprising:
a surface position detection apparatus that detects position surface information for the substrate, wherein
the first adjustment apparatus adjusts the positional relationship based on a detection result from the surface position detection apparatus.

11. The exposure apparatus according to claim 1, wherein the second exposure system comprises a second adjustment apparatus that adjusts a positional relationship between the first shot area and the second shot area.

12. The exposure apparatus according to claim 11, further comprising:
a position detection apparatus that detects position information for the first shot area, wherein
the second adjustment apparatus adjusts the positional relationship based on a detection result from the position detection apparatus.

13. The exposure apparatus according to claim 1, wherein
the first exposure system provides a pattern to the first exposure light using a first mask, and
the second exposure system provides a pattern to the second exposure light using a second mask which has substantially the same pattern density as the pattern density of the first mask.

14. The exposure apparatus according to claim 13, wherein the second exposure system comprises a replacement apparatus that replaces the second mask in accordance with the pattern created on the first shot area.

15. The exposure apparatus according to claim 14, wherein the replacement apparatus comprises a moving apparatus that is capable of moving while holding a plurality of the second masks that have at least a different pattern density.

16. The exposure apparatus according to claim 14 wherein the replacement apparatus comprises a mask holding apparatus that can hold and release the second mask, and a transporting apparatus that transports the second mask to the mask holding apparatus and also transports the second mask away from the mask holding apparatus.

17. The exposure apparatus according to claim 13, wherein the second exposure system comprises an illumination apparatus that exposes the second mask with the second exposure light.

18. The exposure apparatus according to claim 1, wherein the second exposure system comprises an optical component from which the patterned second exposure light exits, and a first drive apparatus that is able to move the optical component.

19. The exposure apparatus according to claim 1, wherein the second exposure system comprises an optical component from which the patterned second light exits, and a substrate holding apparatus that is capable of moving relatively to the optical component while holding the substrate.

20. The exposure apparatus according to claim 1, wherein an irradiation area on the substrate where the second exposure light is irradiated is in a slit shape which is elongated in a first direction within a predetermined plane which is substantially parallel to the surface of the substrate.

21. The exposure apparatus according to claim 20, wherein the second shot area is exposed while relative movement between the substrate and the irradiation area in a second direction which is different from the first direction within the predetermined plane.

22. The exposure apparatus according to claim 20, wherein, when the second shot area is being exposed, the relative position between the substrate and the irradiation area is adjusted in the first direction.

23. The exposure apparatus according to claim 22, wherein the positional relationship is adjusted by moving the irradiation area in the first direction.

24. The exposure apparatus according to claim 22, wherein, during the adjustment of the positional relationship, exposure of the second shot areas is stopped.

25. The exposure apparatus according to claim 20, wherein the exposure of the plurality of second shot areas on the substrate using the second exposure light is divided into at least two exposure operations, and, during these two or more exposure operations, the relative movement between the substrate and the irradiation area is executed in a different direction from the direction during the exposure operations.

26. The exposure apparatus according to claim 25, wherein, during the two or more exposure operations, the substrate is rotated a predetermined angle within the predetermined plane.

27. The exposure apparatus according to claim 20, wherein the second shot area is exposed with the second exposure light by relative movement between the substrate and the irradiation area in the first direction at the same time as the substrate is being rotated within the predetermined plane.

28. The exposure apparatus according to claim 20, wherein the second shot area is exposed with the second exposure light by relative movement between the substrate and the irradiation area in both the first direction and a second direction which is different from the first direction within the predetermined plane.

29. The exposure apparatus according to claim 20, wherein the second exposure light can be irradiated simultaneously onto each one of a plurality of irradiation areas which are located at different positions on the substrate.

30. The exposure apparatus according to claim 20, wherein the second shot area is exposed by moving the substrate and the irradiation area respectively in different directions within the predetermined plane.

31. The exposure apparatus according to claim 20, wherein, during the exposure of the second shot areas, only one of the substrate and the irradiation area is moved.

32. The exposure apparatus according to claim 1, further comprising:
a temperature adjustment apparatus that adjusts the temperature of the substrate before the substrate is exposed by the first exposure system, wherein
the second exposure system exposes the substrate with the second exposure light before the temperature of the substrate is adjusted by the temperature adjustment apparatus.

33. The exposure apparatus according to claim 1, wherein the second exposure system exposes the substrate with the second exposure light after the substrate has been exposed by the first exposure system.

34. The exposure apparatus according to claim 1, wherein the second exposure system is provided either on or adjacent to a path along which the substrate is transported to the first exposure system and along which the substrate is transported away from the first exposure system.

35. The exposure apparatus according to claim 1, wherein at least a portion of the exposure operations of different substrates are performed in parallel by the first exposure system and the second exposure system.

36. The exposure apparatus according to claim 1, wherein the second exposure system creates in the second shot area a pattern which has a broader line width than that of the pattern created in the first shot area by the first exposure system.

37. An exposure apparatus in which a second shot area of a substrate where first exposure light is not irradiated that is located between a first shot area of the substrate which is exposed using patterned first exposure light and an edge of the substrate is exposed using patterned second exposure light while relative movement between the second exposure light and the substrate.

38. An exposure apparatus in which a second shot area of a substrate where first exposure light is not irradiated that is located between a first shot area of the substrate, which is exposed using first exposure light which has been provided with a pattern by a first mask, and an edge of the substrate is exposed using second exposure light which has been provided with a pattern by a second mask having substantially the same pattern density as the pattern density of the first mask.

39. An exposure apparatus in which a second shot area located outside an effective exposure range on a substrate where a first shot area which has been exposed using patterned first exposure light is located is exposed using patterned second exposure light whose pattern density can be varied.

40. An exposure apparatus in which an operation to expose a second shot area which is located outside an effective exposure range of one of a first and a second substrate using patterned second exposure light is executed in parallel with at least a portion of an operation to expose a first shot area which is located within the effective exposure range of the other of the first and the second substrate using patterned first exposure light.

41. The exposure apparatus according to claim 37, wherein a chip that is used to create device is formed in the first shot area, and the chip is not formed in the second shot areas.

42. The exposure apparatus according to claim 1, wherein a plurality of the first shot areas are set within the effective exposure range of the substrate, and a plurality of the second shot areas are set outside the effective exposure range of the substrate.

43. The exposure apparatus according to claim 1, wherein a plurality of the chips are formed on the first shot area.

44. The exposure apparatus according to claim 43, wherein the first shot areas comprises first shot areas having varying numbers of chips thereon.

45. The exposure apparatus according to claim 1, wherein a wavelength of the first exposure light is substantially the same as a wavelength of the second exposure light.

46. The exposure apparatus according to claim 1, wherein the second shot area is smaller than the first shot area.

47. The exposure apparatus according to claim a, wherein no chip can be placed in the second shot area.

48. A device manufacturing method comprising:
exposing a substrate using the exposure apparatus according to claim 1; and
developing the exposed substrate.

49. An exposure method for exposing a substrate comprising:
exposing a first shot area on a substrate with patterned first exposure light by driving a movable component which holds the substrate, a chip which is used to create a device being formed in the first shot area; and
exposing a second shot area on the substrate with patterned second exposure light by relative movement between the substrate and the second exposure light, the substrate being held by a holding component which is different from the movable component, no chip being formed in the second shot area.

50. The exposure method according to claim 49, wherein patterns having substantially the same density as the pattern created in the first shot area is created in the second shot area.

51. An exposure method for exposing a substrate comprising:
exposing a first shot area with a first exposure light, a first mask providing a pattern to the first exposure light, a chip which is used to create a device being formed in the first shot area; and
exposing a second shot area with a second exposure light, a second mask providing a pattern to the second exposure light, the second mask having a pattern density substantially same as a pattern density of the first mask, no chip being formed in the second shot area.

52. An exposure method in which a second shot area of a substrate where first exposure light is not irradiated that is located between a first shot area of the substrate which is exposed using patterned first exposure light and an edge of the substrate is exposed using patterned second exposure light while relative movement between the second exposure light and the substrate.

53. An exposure method in which a second shot area of a substrate where first exposure light is not irradiated that is located between a first shot area of the substrate, which is exposed using first exposure light which has been shaped into a pattern by a first mask, and an edge of the substrate is exposed using second exposure light which has been shaped into a pattern by a second mask having substantially a pattern destiny substantially same as a pattern density of the first mask.

54. An exposure method in which a second shot area located outside an effective exposure range on a substrate where a first shot area which has been exposed using patterned first exposure light is located is exposed using patterned second exposure light whose pattern density can be varied.

55. An exposure method in which an operation to expose second shot area which is located outside an effective exposure range of one of a first and a second substrate using patterned second exposure light is executed in parallel with at least a portion of an operation to expose a first shot area which is located within the effective exposure range of the other of the first and the second substrate using patterned first exposure light.

56. The exposure method according to claim 52, wherein a chip which is used to create device is formed in the first shot area, and the chip is not formed in the second shot area.

57. A device manufacturing method comprising:
exposing a substrate using the exposure method according to claim 49; and
developing the exposed substrate.
